(19) United States
(12) Patent Application Publication
(10) Pub. No.: US 2022/0388879 A1
(43) Pub. Date: Dec. 8, 2022

(54) BIOFILMS IN BIOELECTROCHEMICAL ENERGY CONVERSION CELLS

(71) Applicant: Bugsy Solar LLC, Los Altos Hills, CA (US)

(72) Inventors: Emily A. Stein, San Leandro, CA (US); Jonathan Servaites, San Francisco, CA (US); Keaton Washburn, Portola Valley, CA (US); Justin Azar, San Francisco, CA (US)

(21) Appl. No.: 17/833,697

(22) Filed: Jun. 6, 2022

Related U.S. Application Data
(60) Provisional application No. 63/363,798, filed on Apr. 28, 2022.
(60) Provisional application No. 63/202,333, filed on Jun. 7, 2021.

(51) Int. Cl. C02F 3/28; C02F 3/00

(52) U.S. Cl. CPC C02F 3/28; C02F 3/005; C02F 3/006; C02F 2209/02; C02F 2209/06; C02F 2209/08; C02F 2209/14; C02F 2209/15; C02F 2209/22; C02F 2303/10

(57) ABSTRACT

Presented herein is a voltaic cell containing a biofilm for facilitating energy conversion in a bioelectrochemical energy conversion cell where the biofilm includes one or more microbial populations.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Current voltaic cells and solar panel systems have limited efficiency and require complex materials resulting in significant associated costs. Many solar panels use wafer-based crystalline silicon cells or cadmium or silicon-based thin-film cells. These cells are fragile and must be protected from moisture through adding multiple protective layers. Panels are deployed in series for increased voltage and/or in parallel for increased current. Panels are interconnected through conducting metallic wires. An inherent problem with common systems is the susceptibility of the cells to overheat due to reverse current flow when a portion of the panel is shaded and another portion of the panel is in direct sunlight. Another inherent problem is that solar cells become less efficient at higher temperatures, which limits the geographical effectiveness of light conversion to electricity. Improvements such as arrayed lenses and mirrors improve the focusing of light to increase efficiency but have higher fabrication complexity and associated costs.

While biochemical voltaic cells may be a suitable alternative, biochemical voltaic cells also face many challenges. Biochemical voltaic cells rely on organisms capable of generating energy that can be collected and converted to generate potential energy. However, utilization of these organisms involve maintaining a sufficient level of activity within the cell to keep the organisms alive and operating in a reliable manner. In some instances, organisms can interfere with the operation of the cell itself, such as by generating electricity at levels of current and/or voltage less than or beyond that which is desired for the particular cell. Additionally, maintaining the proper environment to allow sustainable conditions for the organisms to thrive in a biochemical voltaic cells may be challenging as well as costly.

The background description provided herein is for the purposes of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

One aspect involves a voltaic cell including: (a) an anode for receiving electrons and providing electrons to an external circuit or load; (b) a cathode for donating electrons to an electrochemical reaction; (c) a biofilm comprising a microbe, the biofilm in electrical contact with the anode or cathode; (d) a buffer comprising an ionically conductive medium in contact with the anode and cathode; and (e) a vessel at least partially containing the biofilm and the buffer.

In various embodiments, the voltaic cell also includes an ion permeable and electron donor impermeable barrier separating the buffer into an anode compartment and a cathode compartment, thereby preventing the electron donor population from contacting the cathode. In some embodiments, the barrier is electronically conductive.

In some embodiments, the barrier contacts the anode.

In various embodiments, the biofilm is in contact with at least one of the anode and the cathode. In some embodiments, the biofilm is in contact with at least one of the anode, the cathode, and the ion permeable and electron donor impermeable barrier.

In various embodiments, the biofilm includes two or more microbes.

In various embodiments, the biofilm is formed on a substrate in the voltaic cell. In some embodiments, the substrate is either the anode or the cathode. In some embodiments, the substrate contacts a surface of the anode or the cathode.

In various embodiments, the biofilm includes positively charged moieties.

In various embodiments, the biofilm includes negatively charged moieties.

In various embodiments, the biofilm includes synthetic moieties.

In various embodiments, the biofilm includes non-synthetic moieties.

In various embodiments, the biofilm includes one or more filamentous appendages.

In various embodiments, the biofilm includes one or more microbe classes that is one or more of anaerobic, aerobic, and facultatively anaerobic microbes.

In various embodiments, the biofilm includes a sulfur oxidizing microbe and a sulfur reducing microbe.

In various embodiments, the biofilm includes one or more microbes selected from the group consisting of Rhodoferax ferrireducens, Lactobacillus acidophilus, Rhodospirillum rubrum, Desulfovibrio desulfuricans subsp. desulfuricans, Peptostreptococcus anaerobius, Rhodospirillum centenum, Catonella morbi, Lachnospiraceae sp., Photobacterium leiognathi, Allochromatium vinosum, Lactobacillus casei, Fusobacterium nucleatum subsp. polymorphum, Helcococcus kunzii, Cutibacterium acnes, Rhodospirillum rubrum, Helcococcus kunzii, Allochromatium vinosum, and Ferrovum myxofaciens.

In various embodiments, the biofilm includes a matrix including a natural polymer, a synthetic polymer, a hydrate of DNA, a hydrate of a protein, or a hydrate of a carbohydrate.

In any embodiment described above, the voltaic cell may also include a current collector in electrical communication with the anode.

In any embodiment described above, the first species of microbe and/or the second species of microbe includes light harvesting antennae. In various embodiments, the first species of microbe is excited by electromagnetic radiation in a first band, and at least one other species of microbe in the buffer is excited by electromagnetic radiation in a second band, wherein the first band and the second band do not substantially overlap.

In any embodiment described above, the first species of microbe includes a phototrophic or chemo-trophic microbe.

In any embodiment described above, the first species of microbe is a chemotroph and the second species of microbe is a phototroph.

In any embodiment described above, the first primary metabolic pathway oxidizes a compound containing carbon, nitrogen, phosphorous, or sulfur, and the second primary metabolic pathway reduces the oxidized compound produced the first primary metabolic pathway.

In any embodiment described above, the first species of microbe has pili, fibrils, flagella, and/or a filamentous shape.

In any embodiment described above, the first species of microbe has a plurality of metabolic pathways.

In any embodiment described above, the first species of microbe is a naturally occurring microbial species.

In any embodiment described above, the first primary metabolic pathway and the second primary metabolic pathway each participate in cellular respiration.

Another aspect involves a method of converting chemical and/or light energy to electrical energy, the method including: operating the voltaic cell of any of the preceding embodiments.

Another aspect involves voltaic cell including: (a) cathode air flow hardware; (b) a cathode gas diffusion layer; (c) a cathode agar layer; (d) an electrolyte layer including an ionically conductive medium in contact with the anode and cathode; (e) an anode layer for receiving electrons and providing electrons to an external circuit or load; (0 an anode agar layer; (g) window layer; and (h) a biofilm including a microbe.

In various embodiments, the microbe resides in one or more of the layers.

In various embodiments, the anode layer includes material such as any one or more of aluminum nanoparticles, aluminum microparticles, transparent conductor particles, hydrophilic polymers, and hydrophilic gels.

In various embodiments, the window layer includes glass.

In various embodiments, the biofilm is in contact with at least one of the anode and the cathode. In some embodiments, the biofilm is in contact with at least one of the anode, the cathode, and the ion permeable and electron donor impermeable barrier.

In various embodiments, the biofilm includes two or more microbes.

In various embodiments, the biofilm is formed on a substrate in the voltaic cell. In some embodiments, the substrate is either the anode or the cathode. In some embodiments, the substrate contacts a surface of the anode or the cathode.

In various embodiments, the biofilm includes positively charged moieties.

In various embodiments, the biofilm includes negatively charged moieties.

In various embodiments, the biofilm includes synthetic moieties.

In various embodiments, the biofilm includes non-synthetic moieties.

In various embodiments, the biofilm includes one or more filamentous appendages.

In various embodiments, the biofilm includes one or more microbe classes that is one or more of anaerobic, aerobic, and facultatively anaerobic microbes.

In various embodiments, the biofilm includes a sulfur oxidizing microbe and a sulfur reducing microbe.

In various embodiments, the biofilm includes one or more microbes selected from the group consisting of Rhodoferax ferrireducens, Lactobacillus acidophilus, Rhodospirillum rubrum, Desulfovibrio desulfuricans subsp. desulfuricans, Peptostreptococcus anaerobius, Rhodospirillum centenum, Catonella morbi, Lachnospiraceae sp., Photobacterium leiognathi, Allochromatium vinosum, Lactobacillus casei, Fusobacterium nucleatum subsp. polymorphum, Helcococcus kunzii, Cutibacterium acnes, Rhodospirillum rubrum, Helcococcus kunzii, Allochromatium vinosum, and Ferrovum myxofaciens.

In various embodiments, the biofilm includes a matrix including a natural polymer, a synthetic polymer, a hydrate of DNA, a hydrate of a protein, or a hydrate of a carbohydrate.

In any embodiment described above, the voltaic cell may also include a current collector in electrical communication with the anode.

In any embodiment described above, the first species of microbe and/or the second species of microbe includes light harvesting antennae. In various embodiments, the first species of microbe is excited by electromagnetic radiation in a first band, and at least one other species of microbe in the buffer is excited by electromagnetic radiation in a second band, wherein the first band and the second band do not substantially overlap.

In any embodiment described above, the first species of microbe includes a phototrophic or chemo-trophic microbe.

In any embodiment described above, the first species of microbe is a chemotroph and the second species of microbe is a phototroph.

In any embodiment described above, the first primary metabolic pathway oxidizes a compound containing carbon, nitrogen, phosphorous, or sulfur, and the second primary metabolic pathway reduces the oxidized compound produced the first primary metabolic pathway.

In any embodiment described above, the first species of microbe has pili, fibrils, flagella, and/or a filamentous shape.

In any embodiment described above, the first species of microbe has a plurality of metabolic pathways.

In any embodiment described above, the first species of microbe is a naturally occurring microbial species.

In any embodiment described above, the first primary metabolic pathway and the second primary metabolic pathway each participate in cellular respiration.

These and other aspects are described further below with reference to the drawings.

### BRIEF DESCRIPTION OF THE DRAWINGS

FIG. 1A schematically depicts an energy conversion cell in accordance with certain embodiments.

FIG. 1B depicts a variation of the cell shown in FIG. 1A.

FIG. 1C depicts an example photosystem.

FIG. 1D depicts a microorganism-constraining enclosure with an electrode and biofilm in accordance with certain disclosed embodiments.

FIG. 1E depicts two layers that may be implemented in a multi-layer biofilm for a microorganism-constraining enclosure.

FIG. 1F shows a process flow diagram illustrating the arrangement of components for a microbe-based methanol fuel cell.

FIG. 1G shows multiple microorganism-constraining enclosures in accordance with certain disclosed embodiments.

FIG. 1H shows a microorganism-constraining enclosure on an electrode in accordance with certain disclosed embodiments.

FIG. 1I shows a process flow diagram depicting operations that may be performed in accordance with certain disclosed embodiments.

FIG. 2A depicts an example of filamentous shapes formed on a biofilm.

FIGS. 2B-2D show schematic illustrations of biofilms with microbes on a surface.

FIGS. 2E and 2F are schematic illustrations of examples of microbes.

FIG. 2G shows a schematic illustration of connectivity between microbes.

FIG. 2H shows electron flow along a filament of a microbe.

FIGS. 3A, 3B, 3C, and 3D depict biofilms of various shapes on substrate surfaces.

FIG. 4A shows a cross section of an energy conversion cell with a biofilm formed on a substrate.

FIG. 4B shows a porous surface of a biofilm and substrate in the energy conversion cell of FIG. 4A.

FIG. 5A shows an example energy conversion cell in a horizontal format.

FIG. 5B shows an example three-layer conversion cell format.

FIG. 5C shows an example “puck” design for an energy conversion cell in a horizontal format.

FIG. 5D shows a layer of microbe within a biofilm in an energy conversion cell.

FIG. 5E shows a side view of an example voltaic cell that may be used in accordance with certain disclosed embodiments.

FIG. 6 shows a process flow diagram depicting operations that may be performed in a method in accordance with certain disclosed embodiments.

FIGS. 7 and 8 show example energy conversion cells with different carbon-containing anodes.

FIG. 9 shows an example stack of layers that may be implemented as a bioelectrochemical voltaic cell in accordance with certain disclosed embodiments.

FIG. 10 is a graph showing current measured in an experiment performed in accordance with certain disclosed embodiments.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

### I. Definitions

Unless defined otherwise, all technical and scientific terms used herein have the same meaning as commonly understood by one of ordinary skill in the art. Various scientific dictionaries that include the terms included herein are well known and available to those in the art. Any methods and materials similar or equivalent to those described find use in the practice of the embodiments disclosed.

The terms defined immediately below are more fully understood by reference to the specification. The definitions are provided to describe particular embodiments only and aiding in understanding the complex concepts described in this specification. They are not intended to limit the full scope of the disclosure. Specifically, it is to be understood that this disclosure is not limited to the particular compositions, systems, designs, methodologies, protocols, and/or reagents described, as these may vary, depending upon the context they are used by those of skill in the art.

As used in this specification and appended claims, the singular forms “a”, “an”, and “the” include plural referents unless the content and context dictates otherwise. For example, reference to “a cell” includes a combination of two or more such cells. Unless indicated otherwise, an “or” conjunction is used in its correct sense as a Boolean logical operator, encompassing both the selection of features in the alternative (A or B, where the selection of A is mutually exclusive from B) and the selection of features in conjunction (A or B, where both A and B are selected).

An “electron donor” is a component that donates electrons as part of a process that involves conversion of energy from radiation (e.g., light), chemical components, mechanical manipulation, or other process. In this disclosure, examples of electron donors include photosynthetic and non-photosynthetic microbes, light-harvesting antennae, and pigments.

“Light-harvesting antennae” are biochemical or chemical structures capable of being excited by light energy. Of interest, light may excite the antennae to a state allowing them to generate electrical or electrochemical energy. Sometimes, a photosynthetic microbe contains light harvesting antennae.

A “pigment” is any composition capable of being excited by light energy, typically through wavelength-selective absorption. A pigment is one light-harvesting antennae or a component thereof. A pigment may be synthetically or biologically produced.

A “non-photosynthetic microbe” is a microbial cell that does not need light energy for growth and metabolic processes. Such microbe may contain electron transport components, which may be embedded in the cytoplasmic membrane and/or membrane invaginations and/or membrane vesicles and/or organelles.

A “photosynthetic microbe” or “phototrophic microbe” is a microbial cell that uses light energy for growth and metabolic processes. Such microbe typically contains light-harvesting antennae capable of harnessing light energy and electron transport components, which may be embedded in the cytoplasmic membrane and/or membrane invaginations and/or membrane vesicles and/or organelles.

A “chemotrophic microbe” is a microbial cell that uses organic or inorganic oxidation of electron donors in their environments to generate energy for growth and metabolic processes.

An “organotrophic microbe” is a microbial cell that uses organic compounds as electron donors in one or more metabolic pathways used for growth and metabolic processes.

An “lithotrophic microbe” is a microbial cell that uses inorganic compounds as electron donors in one or more metabolic pathways used for growth and metabolic processes.

An “heterotrophic microbe” is a microbial cell that uses organic compounds as a carbon source.

An “autotrophic microbe” is a microbial cell that uses carbon dioxide as a carbon source.

A “biofilm” is a film of microbes including one or more microbe populations that adheres to a surface and is capable of facilitating functions of the bioelectrochemical energy conversion cell. A biofilm may include non-microbial components (e.g., an extracellular matrix).

Extracellular components include but are not limited to polysaccharides, such as chitosan and carrageenan.

An “electron conductive material” is a material that enables the transfer of electrons from one location of the electron conductive material to another location. The electron conductive material may be electronically conductive or semiconductive. It may conduct holes.

### II. Introduction

Bioelectrochemical energy conversion cells are an effective alternative to generating energy. Such cells can use a variety of organisms, including but not limited to photosynthetic organisms, phototrophic organisms, chemotrophic organisms, chemoorganotrophic organisms, chemolithotrophic organisms, photoheterotrophic organisms, autotrophic organisms, heterotrophic organisms, and other organisms capable of generating capturable energy for utilization in a voltaic cell. Electron carriers serially pass excited electrons through the electron transport chain and simultaneously facilitate the coordinated effort of proton separation across the membrane to generate potential energy.

Photosynthetic microbes and plants are highly efficient in converting light energy into other usable forms of energy. Photosynthetic microbes contain light-harvesting pigments and antenna systems or reaction centers in their membranes to harness the energy delivered by a photon.

There are two types of photosynthesis, nonoxygenic and oxygenic. Nonoxygenic photosynthesis is thought to historically precede oxygenic photosynthesis and does not produce oxygen. Oxygenic photosynthesis occurs in plants and cyanobacteria and uses H₂O as an electron donor for phototrophy. Nonoxygenic photosynthesis can utilize hydrogen, sulfur, and certain compounds as electron donors for phototrophy.

The documented ability of maximal light harnessing has been identified in green sulfur bacteria that reside almost 1 mile below the ocean's surface in deep-sea thermal vents where very minimal light reaches these microbes. These microbes can utilize nearly 100% of the residual light in non-oxygenic photosynthesis.

The use of photosynthetic microbes to generate usable energy has focused mainly on biofuel generation.

In addition to, or alternatively to, photosynthetic microbes, bioelectrochemical energy conversion cells may employ chemotropic organisms, including those that may be found in deep areas of oceans. Bioelectrochemical energy conversion cells may also employ heterotrophs which are efficient in converting carbon-containing nutrients into usable forms of energy.

Some bioelectrochemical energy conversion cells may include two or more of the above types of organisms. For example, some bioelectrochemical energy conversion cells may have an organism with energy conversion pathways where products of an energy conversion pathway can be used as an energy source for an energy conversion pathway of another organism in the same bioelectrochemical energy conversion cell.

Disclosed herein is a microbe-based electricity generating cell utilizing a biofilm to increase performance (e.g., efficiency) of the cell. In some implementations, the incorporation of a biofilm allows the cell to provide low cost energy production processes, and high light-to-electricity conversion rates, compared to current bioelectrochemical energy generation technologies. Cells having biofilms can use the biofilm to regulate energy conversion processes within the cell, and can be implemented in diverse geographical locations where such biofilms may naturally occur. The cell may be customizable to address requirements of geography, climate, season, structural needs, etc. In certain embodiments, a cell has one or more biofilms disposed on one or more surfaces in the bioelectrochemical conversion cell.

In certain embodiments, a voltaic cell includes a vessel containing a buffer system, a microbial cell population, one or more biofilms that entrain at least some portion of the microbial cell population, and a current collector. In some embodiments, a voltaic cell includes a vessel containing a buffer system, a microbial cell population, and a conductive biofilm. In some embodiments, a voltaic cell includes a vessel containing a buffer system, a microbial cell population, one or more biofilms, and a current collector. In some embodiments, a voltaic cell includes a vessel containing a light harvesting antennae population, a buffer system, one or more biofilms, a mirror or other optical energy directing component, and a regulator system. In some cell designs, the biofilms can facilitate electron transportation, ion and electron conductivity, and other functions in the cell. In some aspects, a voltaic cell includes a vessel containing a light harvesting antennae population, buffer system, one or more biofilms, electron conductive material, mirror system, and regulator system. In yet other aspects, the voltaic cell includes a vessel containing a microbial population, buffer system, one or more biofilms, a regulator system, and charge storage device. The regulator may have sensing and regulatory feedback functionalities. In some designs, the cell has electricity-generating abilities absent light. In some implementations, the cell is deployed in a solar panel.

### III. Voltaic Cell Embodiments

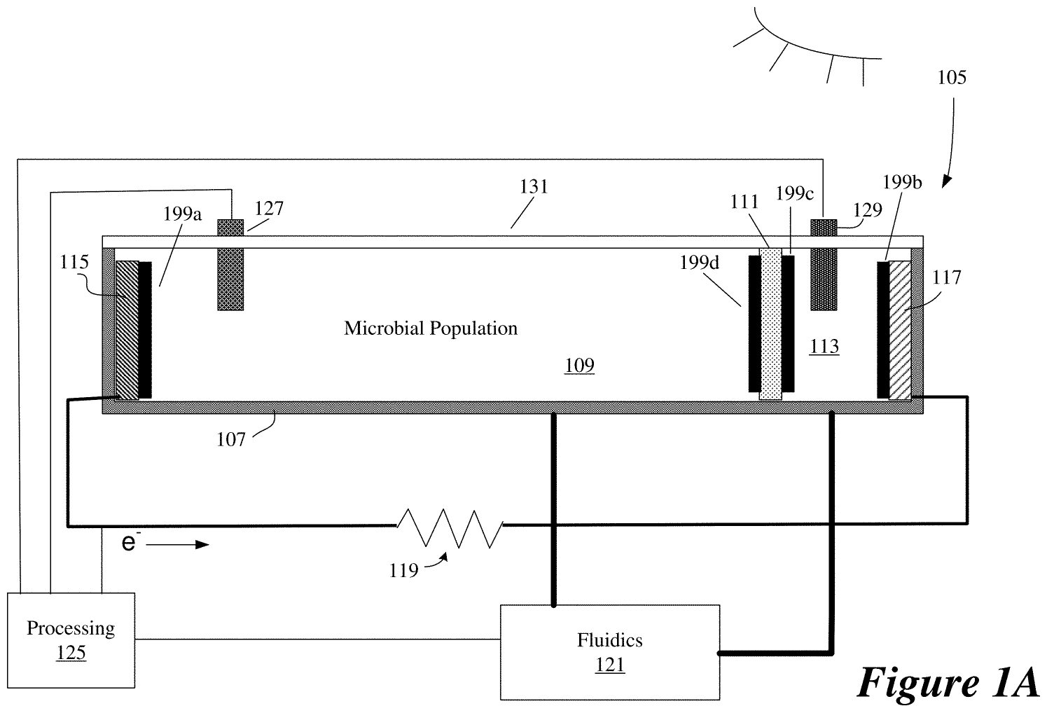

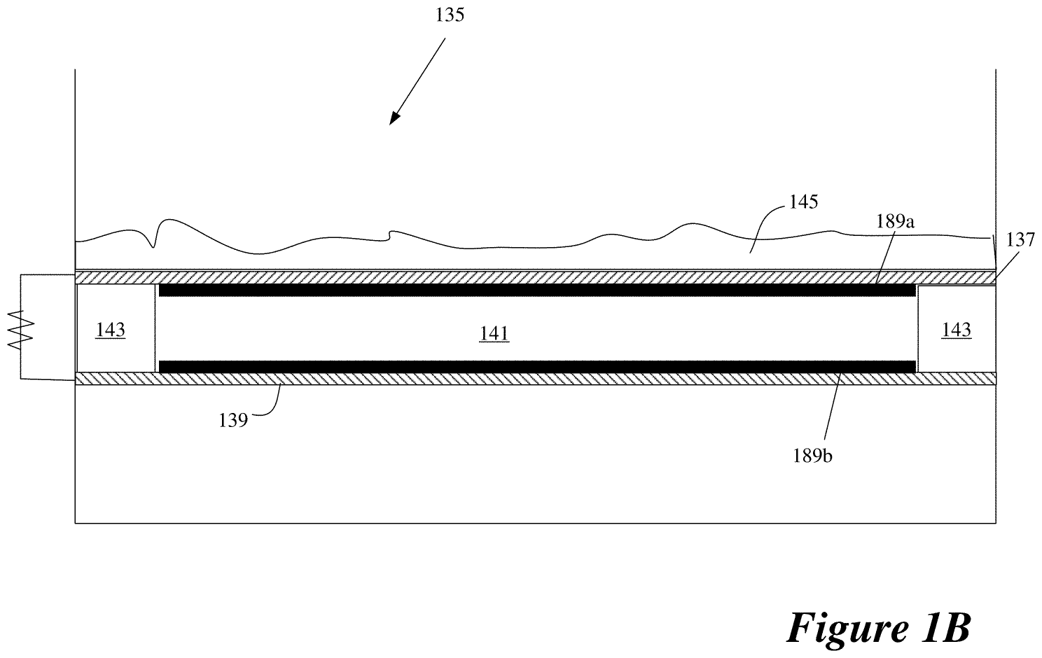

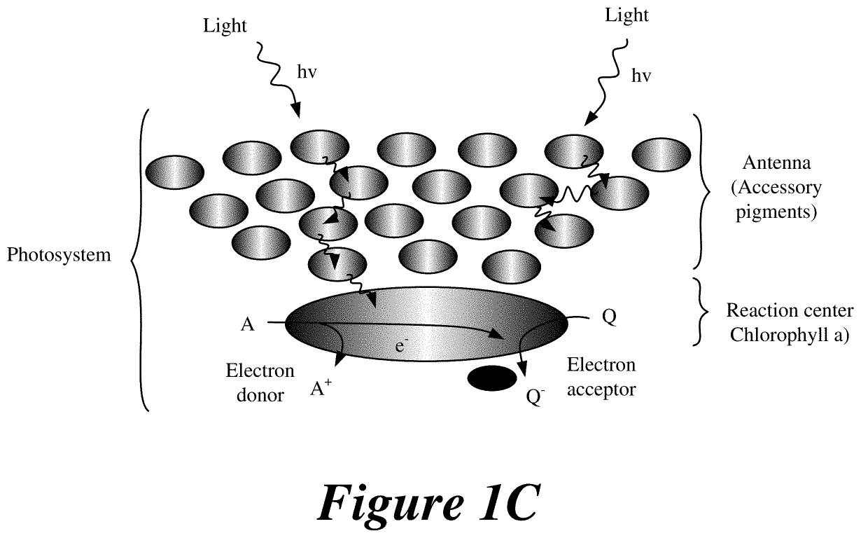

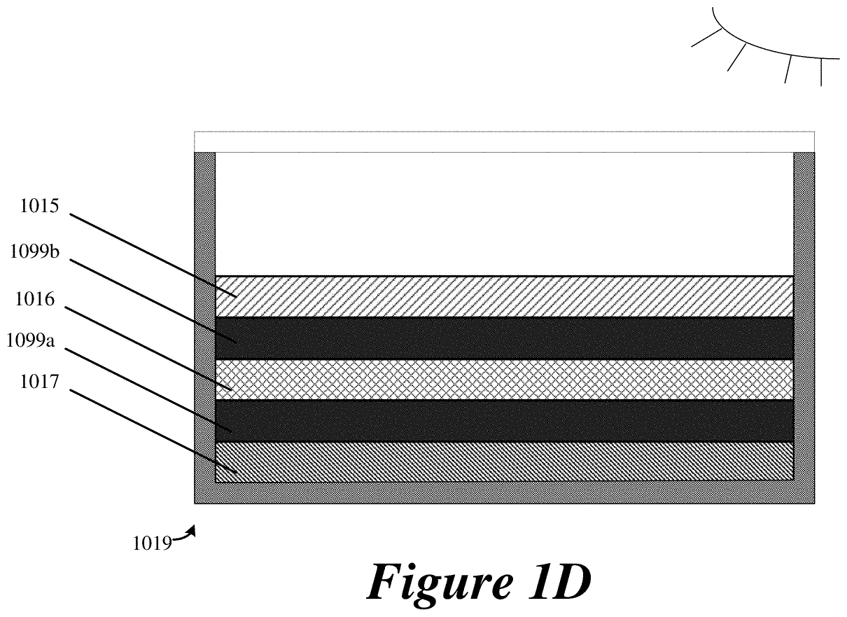

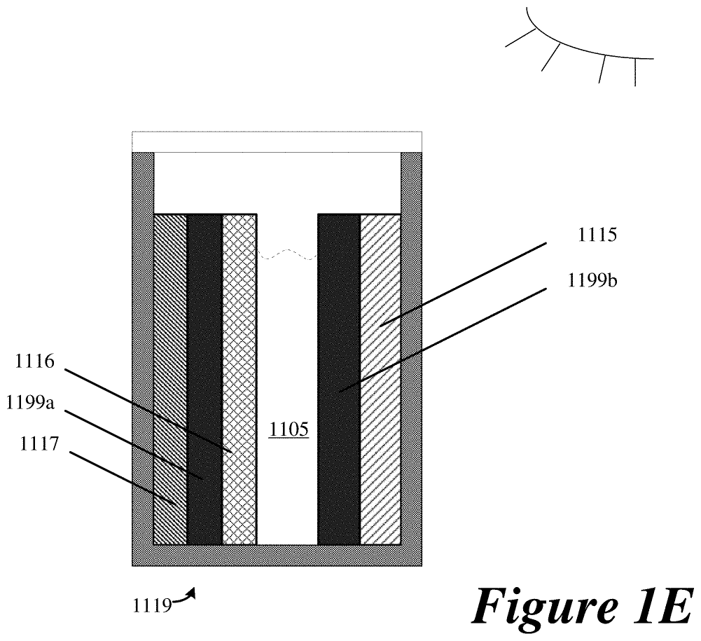

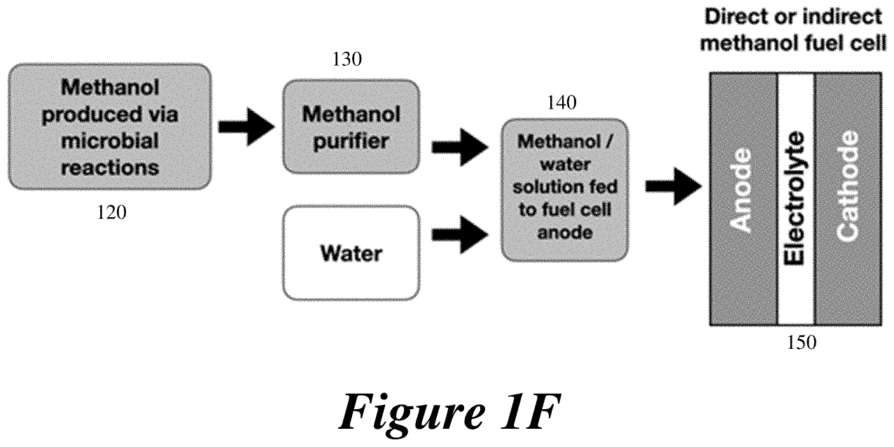

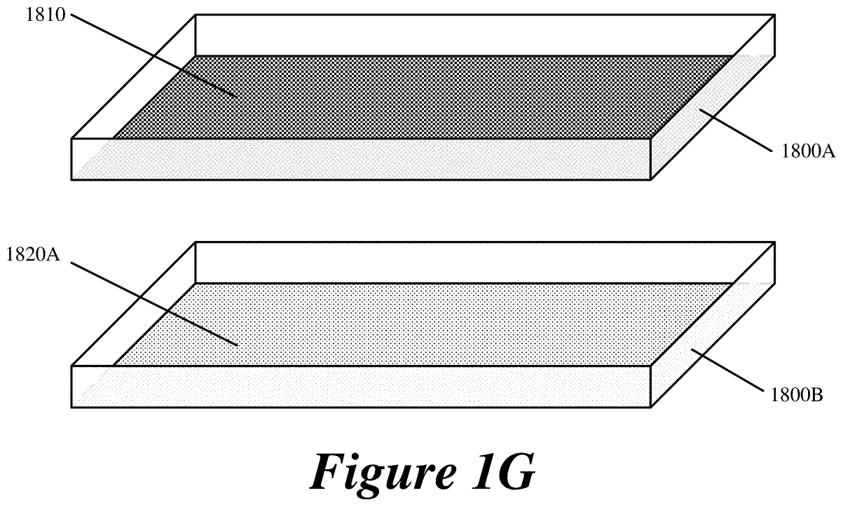

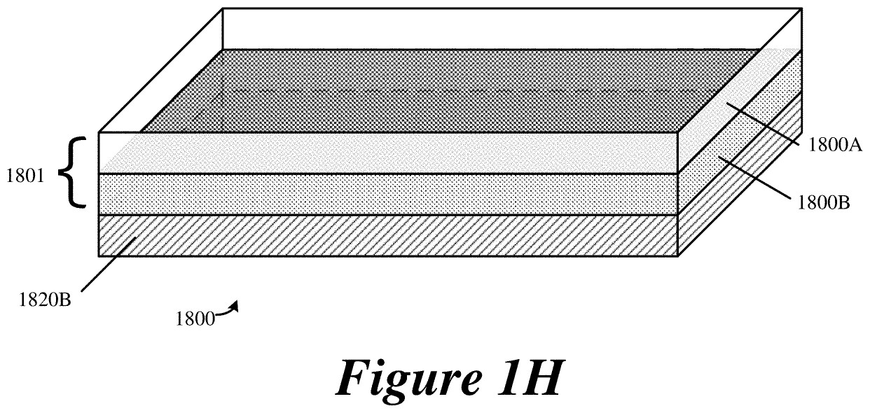

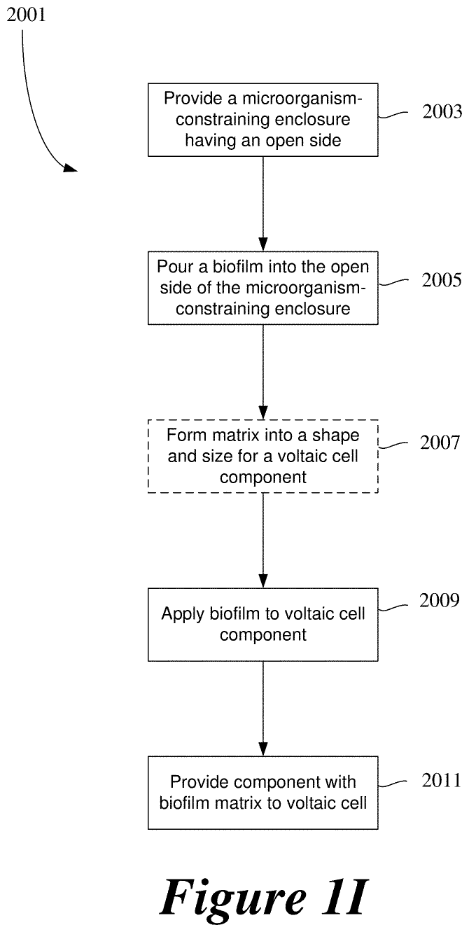

FIG. 1A schematically depicts an energy conversion cell 105 having a containment vessel 107 which holds in its interior 109 a fluid in which one or more microbial populations exist. Cell 105 also includes an optional cover element 131 fitted on top of vessel 107. Element 131 is transparent to radiation in a wavelength range to which the microbial population responds. Optionally, cell 105 includes an ionically permeable barrier or cell separator 111 disposed within the vessel 107 to prevent microbes, electron donors, and/or other components in the interior region 109 from passing into a compartment 113 on the opposite side of permeable barrier 111. It should be understood that permeable barrier 111 is optional and sometimes only a single solution is provided within vessel 107.

Returning to FIG. 1A, cell 105 will include an anode 115 and a cathode 117 electronically separated from one another by ionically conductive fluid in compartment 109 and optionally in compartment 113 if present. The fluid may be a liquid, gel (including hydrogel) or matrix. During operation, the microbial population(s) in compartment 109 may produce electrons that are collected at anode 115. These electrons flow through a load 119 in a circuit coupling cathode 117 and anode 115. In some implementations, microbes in compartment 109 accept protons or other positively charged species from anode 115.

Returning to FIG. 1A, if compartment 113 is used, it may include a separate microbial population. In some implementations, microbes in compartment 113 donate protons or other positively charged species to cathode 117. In some implementations, microbes in compartment 113 accept electrons, protons, or other negatively charged species from cathode 117. The microbes in compartment 109 and optional compartment 113 convert energy by different mechanisms. In various embodiments, at least the microbes within compartment 109 are phototrophic.

As indicated, an energy conversion cell may include one or more biofilms. FIG. 1 depicts optional biofilms on various components of cell 105. Optional biofilms include biofilms 199a, 199b, 199c, and 199d are adjacent to—and sometimes attached to or otherwise in contact with—anode 115, cathode 117, and semi-permeable barrier 111 respectively. A biofilm 199a at the anode 115 can improve electron conductivity and/or perform other functions when electrons are collected at anode 115. For example, microbes in biofilm 199a can donate electrons or other negatively charged species to anode 115. In addition, or alternatively, such microbes can accept protons or other positively charged species from anode 115. Similarly, a biofilm 199b at the cathode 117 can facilitate electron conductivity and/or perform other functions when electrons are transferred from the cathode 117. Microbes present on the biofilms 199b, 199c, and 199d can donate protons or other positively charged species to cathode 117. In addition, or alternatively, such microbes can accept electrons or other negatively charged species from cathode 117. Microbes in the biofilms 199a, 199b, 199c, and 199d can also convert energy by one or more mechanisms. In some embodiments, the microbes are phototrophic.

In certain embodiments, a fluidics system 121 is coupled to the vessel 107 and optionally has separate ports for compartments 109 and 113. The fluidics system 121 may include various elements such as a reservoir for holding make up fluids for compartments 109 and/or 113, one or more pumps, one or more pressure gauges, mass flow rate meters, baffles, and the like. The fluidics system 121 may provide fresh buffer solution and/or microbes to cell 105. It may also deliver one or more of various regulating agents to these fluids. Such regulating agents may include acid, base, salts, nutrients, dyes, and the like. One or more salts may serve as pH buffering agents for the solution. In some cases, a regulating agent includes a redox species that may participate chemically, electrochemically, and/or biochemically to regulate the solution. An example of a redox species is a sulfur-containing species such as hydrogen sulfide (H₂S), sulfur dioxide (SO₂), or sulfate ion (SO₄²⁻). In some embodiments, microbes may be more efficient when included in a biofilm in 199a, 199b, 199c, or 199d than if included in the buffer solution.

Cell 105 may also interface with a controller 125 that controls fluidic system 121. Controller 125 may have one or more other functions. For example, it may receive input from various components of the system such as the circuit coupling anode 115, cathode 117, the fluidics system 121, and/or sensors 127 and 129 provided in compartments 109 and 113, respectively. The sensors may monitor any one or more relevant operating parameters for cell 105. Example such parameters include temperature, chemical properties (e.g., component concentration and pH), optical properties (e.g., opacity), electrical properties (e.g., ionic conductivity), and the like.

FIG. 1B depicts a variation of cell 105. Specifically, the figure depicts an alternative cell 135 having an anode plate 137, a cathode plate 139, and a compartment 141 between plates 137 and 139 as defined by a spacer 143. Within compartment 141 is an ionically conductive medium. Anode plate 137 may contain or be made from a semipermeable material that allows ionic communication between the two sides of the plate but does not permit passage of microbes or microbial components. Provided on top of anode plate 137 is a population 145 of phototrophic microbes containing photon harvesting antennae. Optional biofilms 189a and 189b are adjacent to anode plate 137 and cathode plate 139 respectively. It will be understood that biofilms may also be present on other surfaces of the cell 105.

A light-conversion system may include an anode positioned directly adjacent to a biofilm configured to transfer electrons and produce an electrical current in a circuit containing an anode and a cathode. The circuit may be coupled to a conversion module for an electrical grid or other system.

In one form, a disclosed microbial energy conversion cell includes a vessel containing a buffer system, a light harvesting antennae population, and one or more biofilms. In some aspects of the current disclosure, the cell can include a vessel containing the light harvesting antennae population, buffer, one or more biofilms, mirror system and regulator system.

In some embodiments, a light conversion system includes a light-harvesting antennae component population and one or more biofilms for the improved efficiency of light conversion to electricity at reduced complexity and cost.

In certain embodiments, a light-conversion system includes a buffered electrolyte solution surrounding a microbe-derived light-harvesting antennae population, the population having multiple light-harvesting antennae per component and where the component population has an ability to harvest light over a broad range of wavelengths, including ultraviolet and far red light and can harvest light over a range of intensities, including diffuse light. The population can include one or more microbe species including a mixture of photosynthetic and non-photosynthetic microbes, membranes components derived from the microbes or vesicles containing light-harvesting antennae components and electron carrier components.

In some embodiments, a light-harvesting antennae population contains photosystems, which include light-harvesting pigments or electron carrier molecules and reaction centers. In some implementations, a light-harvesting antennae population contains a range of different light-harvesting pigments and photosystems and may have similar electron carrier molecules.

In some embodiments, a disclosed microbial energy conversion cell includes a vessel containing a buffer system, a microbial population containing one or more chemotrophic microbes, and one or more biofilms. In some aspects of the current disclosure, the cell can include a vessel containing the one or more chemotrophic microbes, buffer, one or more biofilms, mirror system and regulator system.

In some embodiments, an energy conversion system includes a chemotrophic microbial population and one or more biofilms for the improved efficiency of energy source conversion to electricity at reduced complexity and cost.

In some embodiments, an energy conversion system includes an organotrophic microbial population and one or more biofilms for the improved efficiency of carbon conversion to electricity at reduced complexity and cost.

In certain embodiments, an energy conversion system includes a buffered electrolyte solution surrounding a microbial population, the population having multiple microbes and where each microbe has an ability to convert a variety of energy sources in different conditions using a variety of metabolic pathways. The microbial population can include one or more microbe species including a mixture of photosynthetic microbes, non-photosynthetic microbes, chemotrophic microbes, autotrophic microbes, heterotrophic microbes, organotrophic microbes, membranes components derived from the microbes or vesicles containing electron carrier components.

Chemical redox reactions occurring at electrodes convert chemical energy into electrical energy by donating electrons to (anode) or accepting electrons from (cathode) an external electrical circuit. Ions of appropriate charge are consumed or donated at the appropriate electrodes (via the redox reactions) to maintain the local charge balance and overall electrical flow (electrons in the external circuit and ions in cell medium (electrolyte)).

Biological organisms (or components thereof) participate in the operation of the cell. They may (i) facilitate electron and/or ion conduction required by the cell, (ii) they may participate in the energy generating redox reactions at the electrode, and/or (iii) they may harvest energy from an external source (e.g., sunlight for photosynthetic microbes or chemical energy for chemotrophs) and provide the harvested energy in the form of chemical compounds that can participate in the redox reactions at the electrodes.

In certain disclosed embodiments, biofilms are capable of facilitating electron and/or ion conduction, participating in the energy generating redox reactions, and/or harvesting energy from an external source.

One example photosystem may operate shown in FIG. 1C. In some embodiments, the photosystem exists in the cell membrane of a living organism. In some embodiments, the photosystem exists in a membrane derived from a living organism but is no longer part of that organism. In other embodiments, the photosystem is incorporated in a synthetic micellular structure. Such structures can be created by techniques known in the art such as sonicating oil and lipid in a solvent with detergent. The resulting micellular structures can be spiked with the required components of a photosystem. Such components typically include a reaction center such as a molecule of chlorophyll a, light harvesting pigments, and electron shuttling molecules. Certain pigment molecules may serve as both the light harvesting pigments and electron shuttling molecules. In certain embodiments, one or more elements of a photosystem are provided to a biofilm or similar component of a voltaic cell. For example, one or more pigments may be added to a hydrogel or a branched polymeric matrix. Examples of such matrixes include alginate, agar, agarose, pectins, gelatin, and Sephadex.

As light hits the light-harvesting pigments in the microbial membranes, the excited electrons are passed directionally to electron carrier components (antenna accessory pigments in FIG. 1C) in the membrane and to an electron shuttling component that passes the electron to a terminal electron acceptor. In some cases, the shuttling component is a biofilm. Electrons flow out of a microbial membrane onto the biofilm which can help facilitate electron flow. The electron flow can then be harnessed by a neighboring anode, such as a metal plate or wire to maximize the flow of electrical current out of a population of microbes. When the net flow of electrons on one portion of a cell (at one electrode) differs significantly from another portion of a cell (at a different electrode), an electrical current can be generated.

Electrons may flow from the photosystem to the anode by various means. Sometimes, the microbes are directly attached to the anode as a biofilm or other adherent structure. In such cases, the electrons generated by the photosystem move directly from the photosystem to the anode. In other cases, the photosystems are not attached to the anode and electron flow into solution where the electron may be captured and transported by a mediator in the solution or by a biofilm on another portion of the cell such as a biofilm adjacent to a cathode. In a similar embodiment, the electron is delivered to a conductive network linking the anode to the microbes or other photosystem containing elements in solution. In certain embodiments, the photosystem corresponds to a light harvesting antenna.

While photosystems are frequently described as a source of electrons for the disclosed embodiments, non-photosynthetic biochemical processes that produce electrons may be used in place of or besides the photosystems. So, when appropriate, reference to photosystems and similar terms may be considered to include metabolic and other biochemical systems that produce electrons available for donation to an anode in an energy conversion cell.

A. Sterilization

In some embodiments, a bioelectrochemical energy conversion cell is fabricated by a process that includes sterilizing one or more components before or after they are installed in the cell or a partially fabricated cell.

The starting materials for a bioelectrochemical energy conversion cell as described herein should be sterile such that when microorganisms are introduced, only the microorganisms of interest are introduced, and undesired microorganisms are not introduced to the conversion cell. During operation of the bioelectrochemical energy conversion cell, the cell is fully sealed and/or is closed in such way that prevents detrimental microorganisms or conditions exterior to the conversion cell from penetrating the cell environment and device.

As an example, all parts of a bioelectrochemical energy conversion cell may be built and fabricated in a sterile manner. For example, an aluminum anode can be sterilized with a hot water bath followed by ethanol or isopropyl alcohol spray followed by drying or a metal anode can be sterilized by baking in a high temperature oven for 1 hour. Gel media can be made with sterile deionized water or can be made using non-sterile deionized water which is then autoclaved. Gel cooling and molding can be formed with sterilized foil molds covered and placed in a sterile container and placed in a cooling chamber. Carbon cloth can be exposed to 70% ethanol or antiseptic spray followed by drying. Pre-sterilized parts including the containers and sealants are packaged and stored in low throughput shelving and opened at the time of assembly under the hood. Leads can be exposed to ethanol or antiseptic spray and dried.

### IV. Gel and Polymer Electrolyte Bioelectrochemical Energy Conversion Cell Designs

In certain embodiments, a bioelectrochemical energy conversion cell has one or more metal or non-metal containing electrodes that optionally are coated with a biofilm and then an ion conducting polymer.

In certain embodiments, bioelectrochemical energy conversion cells have a gel or polymer electrolyte. In some cases, such cells optionally do not have a distinct liquid electrolyte compartment or region. Ion conduction between the anode and cathode takes place primarily or exclusively in a gel or polymer matrix. In other cases, such cells have a liquid electrolyte portion and a gel or solid electrolyte portion. As an example, such cell may have an electrode coated or partially coated with a biofilm and an ion conducting polymer coated on the biofilm. The entire structure (electrode/biofilm/polymer) contacts a liquid electrolyte in ionic contact with a counter electrode.

FIGS. 1D and 1E schematically illustrates bioelectrochemical energy conversion cells having gel or polymer electrolytes. FIG. 1D shows a simplified schematic illustration of a voltaic cell 1019 having an anode 1017, optional biofilm 1099, polymer electrolyte 1016, optional biofilm 1099b, and cathode 1015. In some embodiments, such as where microbes in the biofilm 1099b are photosynthetic microbes, cathode 1015 is transparent. FIG. 1E shows a simplified schematic illustration of a voltaic cell 1119 having an anode 1117, biofilm 1199ba, polymer electrolyte 1116, liquid electrolyte 1105, optional biofilm 1199b, and cathode 1115.

An electrolyte blocks conduction of electrons while allowing conduction of ions between the anode and the cathode. When the electrolyte is (or includes) a solid or gel, it may be referred to as a separator. In addition to conducting ions, a separator may function to provide a comfortable environment for one or more microorganisms that participate in the electrochemical process that generates electrical energy. A gel or polymer separator may include pores of appropriate dimensions such as in the micrometer scale to accommodate microorganisms. The pores may entrain and/or permit movement (entry and exit) of microorganisms.

In certain embodiments, an electrolyte or separator includes multiple components and at least one of those components is an ionically conducting matrix that having a solid or gel state.

Such matrix may have any of various compositions. In some embodiments, NaCl dissolved in water is used to provide ionic conductivity (i.e., the electrolyte). This may provide a suitable environment for a range of microbes. In some embodiments, salts dissolved in water provide for ionic conductivity. In some embodiments, the water-based electrolyte is absorbed by a gel or polymer. The gel or polymer may be ion-conducting in some embodiments. The gel or polymer may not be ion-conducting in some embodiments. In some embodiments, electrolytes may be used to conduct different types of ions—e.g., H+ and OH−. The electrolyte selected for certain disclosed embodiments may depend on the chemistry of the particular fuel cell or solar cell embodiment, based on the ions that are conducted. For example, if hydrogen fuel cell embodiment is implemented, a H+ (proton) conducting electrolyte may be used.

Examples of suitable gel like matrix material include polysaccharides materials such as alginates (e.g., sodium alginate), agarose, agar, acrylamides, polyacrylamides, glycerine, glycerol, hydrogels, gelatins, pectins, PEGs, celluloses, nucleic acid strands, polyproteins, synthetic polymers, cellulose, other Winogradsky mineral media, and mixtures thereof. Gel-like matrix material may allow viable scaffolding for bacterial growth. In some embodiments, biofilm matrices may also have a calcium source or may be in a calcium-rich buffer solution.

A. Methods of Making

In some embodiments, electrodes can be surrounded or coated by the polymer gel. In such an embodiment, the electrode can be laid down into a mold to which a molten gel is applied and allowed to harden. This allows direct contact between the gel and electrode surface(s).

In some embodiments, electrodes can be inserted into a hardened polymer gel. In such an embodiment, the molten gel is applied to a mold and allowed to harden. The electrode can then be inserted into the hardened gel once the gel is removed from the mold. This allows direct contact between the gel and electrode surface(s) once the gel has become inert.

In some embodiments, a cell may be fabricated by providing a polymer membrane and applying electrodes to either side of the polymer membrane. Application of electrodes may be performed by any deposition technique, including but not limited to printing, coating, and spraying.

In some embodiments, a cell includes a heat source such as geothermal sources for producing microbes that can be assembled into a cell. For any cell embodiment described herein, carbon dioxide consumption from the atmosphere or from a carbon dioxide-generating source such as a vehicle or a combustion power plant may be utilized in conjunction with certain disclosed embodiments.

### V. Electrode Formats that Employ an Ionically Conductive Polymer

An ionically conductive polymer is included along with other electrode components. Collectively, the polymer and other components form an electrode. The ionically conductive polymer may be used in the anode, in the cathode, or both. The ionically conductive polymer may be a cation conductor, an anion conductor, or a mixed anion and cation conductor.

A. Anode Components

An anode includes (a) electrochemically active material that can be oxidized during discharge to give up electrons, (b) optionally electronically conductive material, and (c) optionally ionically conductive material. An anode may be in electrical contact with a current collector, which normally has a negative polarity.

1. Ionically Conducting Material

Depending on the reaction occurring at the anode, an ionically conductive polymer may conduct anions, cations, or both. In certain embodiments employing a metal-containing anode, the ionomer conducts hydroxide ions. For example, an aluminum metal electrode may employ an ionomer that conducts hydroxide ions.

In certain embodiments, the ionically conducting polymer is a cation conducting polymer. A cation conducting polymer preferentially conducts cations (e.g., protons) over anions. In some embodiments, a cation conducting polymer may conduct cations from the anode to the electrolyte. The cations depend on the type of electrode being used. Examples of conducted cations include hydrogen ions, aluminum ions, and zinc ions. Examples of conducted anions include hydroxide, bicarbonate, and bisulfate ions. Chemically, an ionically conductive polymer matrix may include an organic polymer backbone having pendant ionic groups such as sulfonic acid groups, disulfide bonds; aromatic ring structures; methyl groups; phosphate groups; hydroxyl groups; carbonyl groups; aldehyde groups; nitroxyl groups; nitrosonium groups; or quaternary ammonium groups. Ionically conducting polymers may have a main chain containing aromatic cycles, double bonds, or aromatic cycles and double bonds. Ionically conducting polymers having aromatic cycles may have a heteroatom or may have no heteroatoms present. Ionically conducting polymers where the main chain contains aromatic cycles but do not include heteroatoms include poly(fluorene)s, polyphenylenes, polypyrenes, polyazulenes, and polynaphthalenes. Ionically conducting polymers where the main chain contains aromatic cycles and have a nitrogen-containing heteroatom in the aromatic cycle include poly(pyrrole)s (PPY), polycarbazoles, polyindoles, and polyazepines. Ionically conducting polymers where the main chain contains aromatic cycles and have a nitrogen-containing heteroatom outside of the aromatic cycle include polyanilines (PANI). Ionically conducting polymers where the main chain contains aromatic cycles and have a sulfur-containing heteroatom in the aromatic cycle include poly(thiophene)s (PT), and poly(3,4-ethylenedioxythiophene) (PEDOT). Ionically conducting polymers where the main chain contains aromatic cycles and have a sulfur-containing heteroatom outside of the aromatic cycle include poly(p-phenylene sulfide) (PPS). Ionically conducting polymers where the main chain contains double bonds include poly(acetylene)s (PAC). Ionically conducting polymers where the main chain contains both aromatic cycles and double bonds include poly(p-phenylene vinylene) (PPV). An ionically conducting polymer may be a linear polysaccharide. An ionically conducting polymer may be an anionic copolymer polyelectrolyte. In some embodiments, an anionic copolymer polyelectrolyte can assist in ion transfer and supporting the biofilm structure. An ionically conducting polymer has a specific conductivity for anions and/or cations of at least 1 mS/cm. An anion conducting polymer is an ion conducting polymer that conducts anions primarily (although there will still be some small amount of cation conduction). A cation conducting polymer is an ion conducting polymer that conducts cations primarily (e.g., there can still be an incidental amount of anion conduction). In various embodiments, an ion conducting polymer is an organic polymer having pendant ionic groups such as sulfonic acid groups or quaternary ammonium groups.

In addition to a polymer or gel matrix material as described above, an electrolyte or separator may include water that hydrates and/or swells matrix, one or more ion types, one or more biocompatibility agents, and combinations thereof. In one example, extracellular polysaccharides may be used.

In certain embodiments, the thickness of a polymer or gel electrolyte is about 0.025 mm to 10 cm. The thickness of the electrolyte may depend on the microbes used in the cell. In some embodiments, the thickness may be about 25 μm to about 250 μm.

However, some microbes may use a layer thicker than this range.

A polymer or gel electrolyte or electrode may have noteworthy optical properties. In certain embodiments, an electrolyte is transparent or partially transparent to wavelengths in some or all of the UV, IR, and/or visible portions of the electromagnetic spectrum. This may be a beneficial property in systems that employ photosynthetic microorganisms.

In various embodiments, microorganisms are entrained in and/or move through an anode and/or a cathode of the bioelectrochemical energy conversion cell. As explained elsewhere herein, certain microorganisms can facilitate operation of a bioelectrochemical energy conversion cell. In some cases, an ionically conductive polymer contains pores or other openings that can accommodate microorganisms in an electrode. In some embodiments, an ionically conductive polymer contains pores having an average cross-sectional diameter or other cross-section dimension of about 0.1 to 10 μm.

2. Electronically Conducting Material

Optionally, an anode includes an electronically conducting material as one component. Such material may be admixed with other components including an electrochemically active material and an ionically conductive component. The electronically conductive material described here is different from an electronically conductive current collector.

Examples of suitable electronically conducting materials include carbon, metals, organic electronically conductive materials, and conductive oxides, nitrides, etc. If carbon is used, it can be in various forms such as carbon black, graphite, graphene structures, fullerene structures such as nanotubes, etc. If a metal or metal-containing structure is used, it should be inert under the chemical and electrical conditions experienced at the anode. In certain embodiments, the electronically conducting material is a conductive oxide. In some cases, the conductive oxide is a transparent conductive oxide such an indium tin oxide or a fluorinated tin oxide.

In some embodiments, electronically conducting materials may include an insulating backing material such as polyethylene terephthalate (PET) with a PVC leadwire and conductive plastic film having 25% carbon and 75% polyethylene. The material may further include a conductive hydrogel with 20% high polymer material, 59% glycerin, 20% water, and 1% salt.

In some embodiments, particles or other units of an electronically conductive material has a shape or morphology that provides a pathway for electrons to move between locations in an electrode or between an electrode and other bioelectrochemical energy conversion cell component such as a biofilm, an electrolyte, and/or a current collector. In another section, this disclosure further describes characteristics of such electron conductive materials. Examples of such characteristics include the shapes and dimensions of electronically conductive particles. Additionally, the location of the electronically conductive material may be chosen based on the components between which it conducts electrons.

3. Bioelectrochemically Active Material

Many different types of electrochemically active material may be used in the anode. Some of these are described elsewhere herein. In certain embodiments, the electrochemically active material is a metal, a metal oxide, and/or a metal chalcogenide. Examples of anode metals include aluminum, zinc, silver, silver/silver chloride, carbon, carbon modified with histidine, carbon modified with arginine or polyarginine, histidine or polyhistidine, and/or carbon modified by Zwitterionic moiety.

In some embodiments, a fuel cell reducing agent such as hydrogen or methanol can be supplied continuously to the anode where it would be oxidized and donate electrons. Such implementations may utilize microbes that generate methanol or hydrogen. Methanol-oxidizing microorganisms are microbes that use methanol as a carbon source for energy. Some methanol-oxidizing microbes may be those of Bacteria and Eukarya domains. Examples may include Pichia pastoris, Hansensula polymorpha, Candida spp., Trichsporon spp. Further examples are described in Steffen Kolb, Aerobic methanol-oxidizing Bacterial in soil, 300 FEMS Microbiology Letters 1, November 2009, pp. 1-10, available at https://academic.oup.com/femsle/article/300/1/1/528736. Certain microbes may be utilized in a fuel cell reducing agent bilayer design using materials including Nafion along with functionalized carbon doped agar/sodium alginate biofilms.

Methanol fuel cells can be categorized in two general ways—indirect and direct methanol fuel cells. FIG. 1F shows a process flow that may be used to form a methanol fuel cell in accordance with certain disclosed embodiments. In operation 120, methanol is produced via microbial reactions. In operation 130, the methanol is collected and purified. In operation 140, water and purified methanol are combined in a solution fed to a fuel cell anode. Diagram 150 shows a direct or indirect methanol fuel cell having an anode, electrolyte, and cathode, whereby the electrolyte is sandwiched between the anode and the cathode. An indirect methanol fuel cell is also referred to as a reformed methanol fuel cell (RMFC), which has a methanol reformer that reforms methanol into hydrogen and carbon dioxide upstream of the anode. The H₂/CO₂ mixture is then fed to the anode along with low concentrations of reformer contaminants, like carbon monoxide. The H₂ is the fuel at the anode in this case. On the other hand, a direct methanol fuel cell (DMFC) has a methanol/water solution fed directly to the anode. The methanol/water solution then reacts at the fuel cell anode.

In some embodiments, metal-free polymer-based electrodes may be used. Polymer-based electrodes may be formed from polypeptides. Polypeptide-base electrodes may have non-degradable aliphatic backbones with redox active pendant groups. In some embodiments, the polypeptide is an enzyme. In other embodiments, the polypeptide-based electrode is protected from proteolytic and hydrolytic activity. Yet in other embodiments, the polypeptide-based electrode is subject to hydrolytic degradation to form amino acids and serve as both an energy source to the device and also as secondary nutrient sources to the microbial population. In one example, polypeptide backbones can be cathodically conductive material while viologens and nitroxide radicals and other redox active groups may be anodically conductive material. Polypeptide-based electrodes may have the additional advantage of being easily degraded if and when necessary for a no-waste process. Degraded amino acids and other components can also be reused and/or resynthesized to form new electrodes. Polypeptide organic radical battery materials are further described in Nguyen et al., “Polypeptide organic radical batteries,” Nature, Vol. 583, p. 61, May 6, 2021.

In another embodiment, metal-free polymer-based electrodes that are nucleic acid in nature can be formed on a receptive surface or as its own layer. The chirality of DNA organizes the negative charge of the DNA backbone and the hydroxyl moieties on the nucleic acid bases in a manner to provide electron transfer. Orientation of the DNA to generate a polarity can be advantageous in certain embodiments. Moreover, the DNA can be degraded over time to serve as a nutrient source for the microbial population.

2. Overall Composition of the Anode

As indicated, an anode includes an electrochemically active material, an optional electronically conducting material, and an optional ionically conducting material such as an ionically conducting polymer. It may contain other components that do not contribute to the electronic or electrochemical properties of the anode. Examples of such other components include binders and wetting materials. Ranges or relative amounts of these components may vary, of course, depending on cell design, microorganisms employed, and other factors.

In certain embodiments, the anode includes an ionically conducting material in a concentration of about 5% to about 70% by mass or about 15% to about 50% by mass or about 25% to about 40% by mass. In certain embodiments, the anode includes an electronically conducting material in a concentration of about 30% to about 95% by mass or about 50% to about 85% by mass or about 60% to about 75% by mass. In certain embodiments, the anode includes an electrochemically active material in a concentration of less than about 40% by mass, or less than about 25% by mass, or less than about 10% by mass. In some embodiments, the anode includes an ionically conducting material having a concentration of about 0.1% to about 55% w/v (weight/volume). Such embodiments may involve microbes inside or outside the electrochemical cell. For example, a direct methanol fuel cell (DMFC) with methanol-producing bugs would have the microbes outside the fuel cell. In some embodiments, the anode, separator, cathode, and surrounding materials may also provide an amicable environment for microbes participating directly in the electrochemical cell reactions.

In certain embodiments, the anode includes a microbial compatible material in a concentration of about 20% to about 80% by mass, or about 30% to about 70% by mass, or about 35% to about 60% by mass. In certain embodiments, the anode includes electronically conductive particles in a concentration of about 20% to about 80% by mass, or about 30% to about 70% by mass. In certain embodiments, the anode includes less than about 40% electrochemically active material by mass, or less than about 25% electrochemically active material by mass, or less than about 10% electrochemically active material by mass. In some embodiments, an anode may be saturated with water and dissolved ions, such as NaCl, to provide some ionic conductivity. Such embodiments may involve microbes inside the electrochemical cell. However, this does not exclude the possibility of also including microbes outside the electrochemical cell providing additional functions (e.g., microbes outside the electrochemical cell may provide feedstocks to the electrochemical cell and microbes within). In some embodiments, voltaic cells that include anodes such as those described herein may include additional layers, such as but not limited to a conductive carbon layer, a metal layer, a transparent conductive layer, and/or a gas diffusion layer (GDL).

For some implementations, only a relatively small amount of the electrochemically active material is employed compared with the electronically conductive material. For example, an anode may have a relatively low percentage of aluminum powder compared to the percentage of carbon. This is because only a relatively little amount of electrochemically active material is needed to set the potential of the electrode.

To allow the microbes to make a significant contribution to the electrochemical energy conversion process—rather than have a material such as aluminum dictate the energy conversion and electrical properties of the cell—only a small amount of inorganic electrochemically active material may be employed. In certain embodiments, the weight ratio of electrochemically conductive material to electronically conducting material is about 1:1 to 1:5 or less.

An anode can have any of various morphologies. For example, the anode may be a mixture of particles, a free-standing sheet, or a layer or coating on a substrate. In some cases, a sheet is a flexible structure such as a film typically used in a membrane electrode assembly. In some cases, the layer or coating is applied as an ink. In some cases, the substrate is current collector.

In some cases, one or more microorganisms facilitate the operation of the anode. As explained elsewhere herein, a biofilm may be provided on or in the anode.

In certain embodiments, the thickness of the anode is at least about 25 μm in thickness. The maximum thickness of an anode may depend on the microbes used.

An anode may have noteworthy optical properties. In certain embodiments, an anode is transparent or partially transparent to wavelengths in some or all of the UV, IR, and/or visible portions of the electromagnetic spectrum. This may be a beneficial property in systems that employ photosynthetic microorganisms. In some cases, a transparent electrode employs a transparent conductive oxide such an indium tin oxide or a fluorinated tin oxide.

In some embodiments, the anode is not transparent. In some embodiments, the anode is opaque.

B. Cathode Components

A cathode includes (a) electrochemically active material that can be reduced during discharge to accept electrons from a circuit, (b) optionally electronically conductive material, and (c) optionally ionically conductive material.

In certain embodiments, the cathode may be similar to a conventional air electrode in, e.g., a fuel cell. It may include a gas diffusion layer having, e.g., carbon particles or fibers and a hydrophobic material such as a fluorinated polymer (e.g., PTFE). It may also have a flow path for air reach the electrode, which flow path may have any of various pathways. In one example, the flow path includes a plurality of parallel paths. In some cases, the flow paths follow a serpentine path. In some implementations, the cathode, which may be an air cathode, is opaque or otherwise non-transparent to a substantial region of the solar spectrum. For this reason, bioelectrochemical energy conversion systems that employ phototrophs may be designed so that the cathode is not disposed between a region where the phototrophs are located and a direction from which solar radiation contacts the cell. In some embodiments, the cathode includes carbon particles and Nafion ionomer as an ink or a paste. This may be fabricated by using a paste including a platinum catalyst supported on carbon, Nafion suspension or solution, and solvents, and removing the platinum to form a carbon-containing paste. The paste may be mixed in isopropyl alcohol. In some embodiments, Nafion may be replaced with a polymer or a gel to change the pH, provide a biocompatible environment, and reducing cost of fabrication. In some embodiments, microbes may be incorporated in the carbon layer. In some embodiments, the carbon layer may be made of alternative conductive carbon materials such as graphite, graphene, or carbon nanoparticles. In some embodiments, conductors may replace carbon in the cell, such as by using metal particles (e.g., silver) and/or conductive metal oxides.

An air cathode requires access to air. In some embodiments, this is accomplished by bioelectrochemical energy conversion cell designs in which at least one surface or side of a cathode of exposed to air. In some horizontal configuration cell designs, a portion of the air electrode extends beyond the electrolyte or buffer and contacts the air. In some implementations, air is provided via, for example, a pump that forces air to the cathode.

Water management may be a consideration in certain cell designs, particularly those employing an air cathode. Some electrode reactions consume water and some generate water. Additionally, water may evaporate from a cell. If there is a net water loss in the cell, some mechanism is provided for providing water to replenish the cell. In some embodiments, a pump is used for this purpose.

C. Methods of Making Electrodes

In one embodiment, an anode is prepared and applied to a substrate as a carbon ink that includes a liquid carrier such as ethanol, carbon particles, a defined amount of aluminum powder or other electrochemically active material, and ionically conductive polymer. After the ink is applied, the liquid is allowed to evaporate and an anode forms on the substrate. As examples, the substrate may include a current collector, a glass sheet, or a transparent plastic sheet.

In another embodiment, polypeptide or DNA in liquid form is applied to a mold and some or most of the water is removed by heating, lyophilization or evaporation. The resultant electrode can be a gel or powder.

In another embodiment, the electrode can be formed onto a backbone/surface with specific structural features and can be sprayed or deposited onto the backbone structure/surface and allowed to cure.

Sonication or a similar technique may be used to assist with carbon ink and aluminum powder dispersion in some embodiments.

In fabricating aluminum anodes, a separate current collector may not be used. Leads may be embedded directly into the gel during fabrication.

### VI. Electron Conductive Pathways in Electrodes

In some embodiments, a bioelectrochemical energy conversion cell includes structures within the electrolyte or electrode that provide electron conductive pathways. These pathways may be provided as structures that facilitate the transfer of electrons donated by microbial species. The structures transport donated electrons to an electrode or a component associated with an electrode such as a current collector. In some cases, the structures transfer electrons to an electrochemically active redox material in the electrode.

The structures providing electron pathways may be naturally occurring or synthesized and/or provided to facilitate electron pathways. In some embodiments, structures are intentionally formed to have particular characteristics specific to the selection of microbial populations and their corresponding thriving environments. In some embodiments, the structures are mixed in the electrode itself—e.g., in the anode, which accepts electrons for an electrical circuit to which the bioelectrochemical energy conversion cell is attached. Alternatively, these materials may be placed at an interface of an electrode, such as at an interface between an anode and the electrolyte.

Electron pathways may be composed of any of a number of electron conducting materials. Examples include carbon-containing materials, metals such as copper, and transparent conductive materials such as fluorinated tin oxide and indium tin oxide. As an example, a carbon-containing material may be a carbon fullerene structure such as a nanotube. In some embodiments, structures are electron siphons. Lengths may vary based on design, however in preferred embodiments, lengths range from 5 nm to 5 cm per unit, may range in shape from coils, cylinders, dots, wires, rods, pili and mesh and can be comprised of carbon, metals, biopolymers.

In some embodiments, electron pathways are provided as a powder or granular material. In some embodiments, they are provided on a continuous substrate such as a sheet. The sheet, for example, may include a transparent conductive oxide. In some cases, a sheet-like structure is etched to give it greater surface area. The etching may produce fingers or lines that facilitate the movement or direction of movement of electrons.

The structures that provide the electron pathway will typically be shaped to transport electrons from one region to another. To this end, they may be wire-like or wire-shaped. In certain embodiments, they have, on average, an aspect ratio that is greater than 1 or greater than 3. The average particle length (direction of electron transport) may be at least about 5 nanometers, or about 5 nanometers to 500 millimeters.

Such structures may be in direct or indirect contact with conductive components of the bioelectrochemical conversion cell, such as electronically conductive material, anodically conductive material, cathodically conductive material, and ionically conductive material. The structures are selected and formed to help facilitate electron movement from one or more of the microorganisms to the electrode without contacting the counter electrode which would create a short-circuit. The electron conducting pathways may be used in conjunction with an ion conducting polymer which helps keep one or more microorganisms in a location in close proximity to an electrode where they can donate the electrodes and avoid transport of electrons to the counter electrode.

A. Method of Incorporating Electron Conducting Pathways in Bioelectrochemical Energy Conversion Cells

Embodiments that involve mixing the electron conducting pathway(s) with one or more constituents of an electrode, biofilm, electrolyte, or other component of a bioelectrochemical energy conversion cell.

In certain embodiments, an anode is prepared and applied to substrate having an etched transparent conductive material such as a transparent conductive oxide (e.g., indium tin oxide). Etching may be conducted using a chemical etchant, a laser, or other agent for partially removing material.

### VII. Microorganism-Constraining Enclosures (Cages)

In certain embodiments, a bioelectrochemical energy conversion cell is fabricated using one or more microorganism-constraining enclosures (sometimes referred to as “cages”) to maintain microorganisms in position during cell fabrication and operation.

FIG. 1G illustrates a microorganism-constraining enclosure 1800A in a perspective view. As illustrated, the structure fully encloses a region occupied by a microorganism 1810. Such enclosure may be used during fabrication of a bioelectrochemical cell. For example, one or more types of microorganism in a liquid or gel medium may be provided within an enclosure, which is then positioned within a vessel of a bioelectrochemical energy conversion cell and subsequently converted to a biofilm or a portion of a biofilm, optionally by adding a matrix-forming material. FIG. 1G shows a second microorganism-constraining enclosure 1800B in a perspective view having a second microorganism 1820A.

FIG. 1H shows a microorganism-constraining enclosure 1800A and a microorganism-constraining enclosure 1800B in situ in a multi-layer biofilm 1801 of a bioelectrochemical energy conversion cell 1800 having electrode 1820B. The microorganism-constraining enclosure 1800A may have walls made of polypropylene material or borosilicate tempered glass.

In certain embodiments, the enclosure has pores in its walls, which pores allow water or other fluid to pass between the inside and the outside of the enclosure. However, the pores are typically too small to allow microorganisms to pass from the inside to the outside of the structure. Such pores may be less than about 0.22 μm in diameter. Pores may also be sealed with a filter to allow flexibility in pore size to adjust to water flow while preventing loss of microorganisms from the cell.

In some cases, a process for forming a biofilm starts with a microorganism-constraining enclosure having an open side. FIG. 1I shows a process flow diagram depicting operations that may be performed in accordance with such a process 2001. In an operation 2003, a microorganism-constraining enclosure having an open side, such as the microorganism-constraining enclosures depicted in FIG. 1G, is provided. In an operation 2005, a liquid or gel medium comprising the microorganism that is to be incorporated into a biofilm is poured into the open side of the microorganism-constraining enclosure. The enclosure encircles some or all the microorganism medium. Optionally, the microorganism-constraining enclosure is closed to maintain microorganisms within the interior during fabrication. In an operation 2007, the constrained microorganisms in the enclosure are optionally mixed and incorporated into a material that forms the substrate or matrix of a biofilm. For example, the microorganism-constraining enclosure may be mixed with or placed into an alginate and/or agarose containing matrix. In an operation 2009, the resulting biofilm may then be applied to a voltaic or bioelectrochemical energy conversion cell component. In an operation 2011, the component with the biofilm matrix may then be incorporated into a bioelectrochemical energy conversion cell.

### VIII. Roles of Biofilms

Disclosed voltaic cells include biofilms in one or more locations that each may have one or more functions to facilitate energy generation in the voltaic cell. Biofilms can be used as stabilizing factors for the microbial community. Biofilms may also increase efficiency of electron transport, by doing so on a solid surface. Biofilms in certain disclosed embodiments perform many different functions.

In some embodiments, microbes can facilitate electron and/or ion conduction required by the cell, participate in the energy generating redox reactions at the electrode, and/or harvest energy from an external source. Any one or more of these roles may be performed better when microbes are present in a biofilm compared to when they are not in a biofilm. For example, microbes that are suspended in the electrolyte or buffer medium may have reduced energy generation, reduced electron and/or ion conduction, or slower redox reactions than compared to the same microbes performing the same functions when arranged in a biofilm.

Biofilms may provide a medium for syntrophic relationships when two or more microbes are present on the biofilm. For example, two microbes having complementary pathways on the same biofilm can collectively generate more energy together because waste products generated by a metabolic pathway of a first microbe are more efficiently consumed by the second microbe. Examples of which can include a sulfur oxidizer paired with a sulfur reducer; a nitrogen oxidizer paired with a nitrogen fixer; photosynthesizer (carbon fixer) paired with an organoheterotroph.

Additional examples of microbes having complementary pathways are discussed in U.S. Pat. No. 10,090,113, issued on Oct. 2, 2018, which is herein incorporated by reference in its entirety for purposes of providing examples of complementary pathway microbes. As other examples, two organisms in a biofilm may communicate beneficially, become heartier due to any of various types of symbiosis, etc.

Example microbes that may be used in biofilms include but are not limited to Bacillus spp., Rhodopseudomonas spp. (e.g., Rhodopseudomonas palustris), Geobacter spp. (e.g., Geobacter sulfurreducens), Acidithiobacillus spp., Shewanella spp. (e.g., Shewanella oneidensis), Desulfobacterales spp., Desulfovibrionales spp., Syntrophobacterales spp., Desulfotomaculum spp., Desulfosporomusa spp., Desulfosporosinus spp., Thermodesulfovibrio spp., Thermodesulfobacteriae spp., Thermodesulfobium spp., Archaeoglobus, Thermocladium, Caldivirga, Proteus spp., Pseudomonas spp., Salmonella spp., Sulfurospirillum spp., Desulfomicrobium spp., Pyrobaculum spp., Chrysiogenes spp., Neisseria spp., Escherichia spp., Eikenella spp., Corynebacterium spp., Rhodospirillum spp., Rhodobacter spp., Aquaspirillum spp., Pirellula spp., Nostoc spp., Helicobacter spp., Enterobacter spp., Photobacterium spp., Brucella spp., Borrelia spp., Azoarcus spp., Dinoflagellata spp., Zooxanthellae spp., Azotobacter spp., Parabasalia spp., Aeromonas spp., Thermococcus spp., Methanopyrus spp., Thermoplasma spp., Pyrococcus spp., Methanococcus spp., Desulfurococcus spp., Methanoculleus spp., Archeoglobus spp., Thiobacillus spp., Synechococcus spp., Spirillum spp., Sphaerotilus spp., Ruminobacter spp., Roseobacter spp., Streptomyces spp., Spirulina spp., Vorticella spp., Xanthophyceae spp., Propionibacterium spp., Leptothrix spp., Frankia spp., Pleurocapsa spp., Chloroflexus spp., Beggiatoa spp., Anabaena spp., Ustilago spp., Megnetospirillum spp., Moorella thermoacetica, Desulfobacter spp., Desulfococcus spp., Desulfovibrio spp., Erythrobacter spp., Thermotoga spp., Rhodoferax spp., Pelobacter spp., Carboxydothermus spp., Lawsonia spp., Thermodesulfobacterium spp., Desulfuromonas spp., Methanofollis spp., Methanosarcina spp., Methanosphaera spp., Methanothermobacter spp. Crenarchaeota/Thaumarchaeota, Euryarchaeota from group I (e.g., Duboscquellida) and group II (e.g., Syndiniales) alveolates, Radiozoa dominating plankton, and Opisthokonta and Alveolates, Alteromonas macleodii ‘surface ecotype’, Pelagibacter ubique Nitrosopumilus maritimus, Chlorobium, Chloroherpeton, GSB1, Prochlorococcus, Porphyrobacter, Cyanidium, Phaeodactylum, Chromatium spp., Roseiflexus spp. and Porphyrobacter spp., others, and other microbes with type IV pili or electron accepting outer membrane components (Reguera et al, 2006; Leang et al., 2010; Richter et al., 2012), which is incorporated herein by reference in its entirety.

Specific examples of microbes that may be used in biofilms include but are not limited to Rhodoferax ferrireducens, Lactobacillus acidophilus, Rhodospirillum rubrum, Desulfovibrio desulfuricans subsp. desulfuricans, Peptostreptococcus anaerobius, Rhodospirillum centenum, Catonella morbi, Lachnospiraceae sp., Photobacterium leiognathi, Allochromatium vinosum, Lactobacillus casei, Fusobacterium nucleatum subsp. polymorphum, Helcococcus kunzii, Cutibacterium acnes, Rhodospirillum rubrum, Helcococcus kunzii, Allochromatium vinosum, and Ferrovum myxofaciens. Table 1 lists these examples and characteristics of these microbes that may facilitate bioelectrochemical voltaic cell function when formed in a biofilm.

| | | | O₂ | Metabolic |
|---|---|---|---|---|
| Name | ATCC Cat# | pH | Characteristics | Characteristics |
| Rhodoferax ferrireducens | BAA-621 ™ | 6.5 | facultative | oxidizes acetate, |
| | | | anaerobe | reduces iron (ferric, |
| | | | | Fe(III)) |
| Lactobacillus acidophilus | 4356 ™ | | any | consumes sugar, |
| | | | | acidifier, H+ |
| Rhodospirillum rubrum | 11170 ™ | 7.2 | any | needs light, has |
| | | | | B880 antenna |
| Desulfovibrio desulfuricans | 27774 ™ | | facultative | makes Fe—S proteins |
| subsp. desulfuricans | | | anaerobe | |
| Peptostreptococcus | 27337 ™ | | anaerobic | consumes sugar, |
| anaerobius | | | | acidifier, H+ |
| Rhodospirillum centenum | 51521 ™ | | any | uses sugar + light at |
| | | | | same time |
| Catonella morbi | 51271 ™ | | anaerobic | consumes sugar, |
| | | | | acidifier, H+ |
| Lachnospiraceae sp. | TSD-26 | | anaerobic | consumes sugar, |
| | | | | acidifier, H+/eats |
| | | | | plant cellulosic |
| | | | | materials and makes |
| | | | | short chain fatty |
| | | | | acids and ethanol |
| Photobacterium leiognathi | 33469 ™ | | aerobic | strongly |
| | | | | bioluminescent |
| Allochromatium vinosum | 17899 ™ | 3-4 | anaerobic | needs light |
| Lactobacillus casei | 393 ™ | | facultative | consumes sugar, |
| | | | anaerobe | acidifier, H+ |
| Fusobacterium nucleatum | 10953 ™ | | facultative | electron sink |
| subsp. polymorphum | | | anaerobe | |
| Helcococcus kunzii | 51366 ™ | | anaerobic | consumes sugar, |
| | | | | acidifier, H+, gets |
| | | | | along with many |
| | | | | species |
| Cutibacterium acnes | 11827 ™ | | anaerobic | makes sugars |
| Rhodospirillum rubrum | 11170 ™ | | any | photosynthetic + |
| | | | | heterotrophic |
| Helcococcus kunzii | 51366 ™ | | aerobic | consumes sugar, |
| | | | | acidifier, H+ |
| Allochromatium vinosum | 17899 ™ | | aerobic | photosynthetic |
| Ferrovum myxofaciens | BAA-2595 ™ | 2.0 | aerobic | iron/sulfur redox |
| Picrophilus oshimae | 700037 ™ | 0.7 | aerobic | consumes sugar + |
| | | | | reduces sulfur |

In another example, two microbes that utilize different regions of the solar spectrums can generate more energy together by converting energy without having to compete for resources.

In another example, two microbes that use different types of energy may benefit from the presence of a biofilm. For example, one microbe may be a chemotroph, obtaining energy by oxidizing electron donors from their environments, while another microbe may be a phototroph, which uses solar energy.

In another example, two microbes that use different sources as electron or hydrogen donors may be used in the presence of a biofilm. For example, one microbe may be an organotroph while another may be a lithotroph.

In another example, two microbes that use different organic compounds as energy may be used in the presence of a biofilm. For example, one microbe may be a heterotroph while another may be an autotroph.

In another example, two microbes that obtain energy using metabolic pathways that involve different catalysts may also be utilized. For example, an anaerobic microbe can be combined with an aerobic organism.

In another example, the electron conducting structures are designed to ensure the electrons generated or consumed by the microorganisms contact the electrode and do not contact the counter electrode where they could cause a short-circuit of the cell. The electron conducting pathways may be used to conduct electrons using an ion conducting polymer electrolyte which helps maintain the microorganisms in a location close to electrode where they can donate the electrodes and avoids transport of electrons to the counter electrode.

Two or more microbes that may be used including two or more of the following types of microbes: phototrophs, photoorganotrophs, photolithotrophs, photoorganoheterotrophs, photoorganoautotrophs, photolithoheterotrophs, photolithoautotrophs, chemotrophs, chemoorganotrophs, chemolithotrophs, chemoorganoheterotrophs, chemoorganoautotrophs, chemolithoheterotrophs, chemolithoautotrophs, and mixotrophs.

Specific combinations of microbes that may be utilized with a biofilm may be selected based on complementarities, ability to thrive under same or similar conditions such as temperature, pH, salinity, predominant gas species, hydrodynamic flow conditions, resistance to chemical species, light exposure, type of light exposure, biofilm environment (such as having a common extracellular matrix), or combinations thereof.

Additional examples of biofilms having syntrophic relationships when two or more microbes are present on the biofilm.

In some embodiments, biofilms may include features that can maintain an environment for the microbes selected. For example, a gel having time-release nutrients (carbohydrate disks, nano and micropelleted amino acids, CO₂/O₂ gas cartridges), buffering agents (citric acid, acetic acid, potassium phosphate, CHES, borate), acids (hydrochloric acid, perchloric acid, glacial acetic acid, phosphoric acid, nitric acid), or bases (sodium hydroxide, sodium bicarbonate, calcium carbonate, potassium hydroxide) may be used to optimize the environment for specific microbes. Additional examples include but are not limited to time release pH adjusters (e.g., zwitterionic compounds such as histidine and buffer materials such as boric acid) and time release nutrients. Boric acid may be added in the synthesis of the biofilm to provide prolonged acidic environment for acidophile microbes. In some embodiments, a poly-histidine tag may be used.

In some embodiments, microbes may form a morphologic structure within a biofilm that would not typically be expected to be formed if the microbe is not in a biofilm. The morphologic structure used can improve efficiency to improve the function of the microbe, such as by increasing the electron and/or ion conduction required by the cell, increased reaction rate or catalysis of energy generating redox reactions at the electrode, and/or increased energy harvested from an external source. In some embodiments, the morphologic structure formed is an electron, chemical, or ion transporting filament that facilitates transport between an electrolyte and an electrode.

In some embodiments, a biofilm includes a single species of microbe. In some embodiments, a biofilm includes two or more species of microbes.

Microbes in a biofilm may take any particular shape or topography. In some embodiments, microbes grow randomly on a biofilm surface. In some embodiments, microbes grow in preferential formations on a biofilm surface. In some embodiments, microbes grow on top of one another on a biofilm surface. In some embodiments, microbes grow preferentially along a common axis of a surface. In some embodiments, microbes are arranged in such way that they each self associate with one another to maximize utilization of nutrients.

In some embodiments, microbes float in a bioelectrochemical voltaic cell.

In some embodiments, microbes that produce methanol (e.g., “methanogens”), or microbes that consume methanol, or both may be used in a methanol fuel cell embodiment. In some embodiments, a matrix may be fabricated from pectin or may be added to agar, agarose, and/or polyacrylamide and methanol-producing microbes may be grown to generate methanol in a methane fuel cell embodiment.

Example methylotrophic microorganisms include but are not limited to Alpha-, Beta-, and Gammaproteobacteria, Verrucomicrobia, Firmicutes, and Actinobacteria; and members of the Classes Actinobacteria, Spirochaetes, Alpha-, Beta-, Gamma-, and Deltaproteobacteria, of the Phyla Firmicutes, Bacteroidetes, Chloroflexi, Acidobacteria, Nitrospirae, Verrucomicrobia, Cyanobacteria, and Planctomycetes, and/or of the domain Archaea.

Methanogens may be grown by electrosynthesis. In some embodiments, methanogens may be grown along or on electrically conductive nanowires or pili, by direct membrane or electrode contact with anodes or cathodes, or by diffusion of extracellular electron carriers. Methanogens may be grown using photons to conserve energy or to photocatalyze certain metabolic reactions. In some embodiments, methanogens may synthesize photoactive cofactors which may act as chromophores for transmembrane ion pumping or photocatalytic redox reactions.

Example methanogen orders include Methanopyrales (such as Methanopyrus kandleri), Methanococcales (such as Methanococcus maripaludis), Methanobacteriales (such as Methanobacterium thermoautotrophicum), Methanosarcinales (such as Methanosarcina mazei), Methanomicrobiales (such as Methanospirillum hungatei), Methanocellales (such as Methanocella paludicola), Methanomassiliicoccales (such as Methanomassiliicoccus luminyensis), Halobacteriales (such as Halobacterium salinarum), Thermoplasmatales (such as Thermoplasma volcanium), and Archaeoglobales (such as Archaeoglobus fulgidus). Methanogensis pathways may be hydrogenotrophic, methylotrophic, carboxydotrophic, or acetoclastic. In some embodiments, certain methanogen orders may be aerobic halophilic heterotrophs (such as Halobacteriales), thermophilic heterotrophs (such as Thermoplasmatales), or anaerobic sulfate reducers (such as Archaeoglobales). Example hydrogenotrophic methanogen orders include Methanopyrales, Methanococcales, Methanobacteriales, Methanosarcinales, Methanomicrobiales, and Methanocellales. Example methylotrophic methanogen orders include Methanosarcinales and Methanomassiliicoccales. An example carboxydotrophic methanogen order is Methanosarcinales. An example acetoclastic methanogen order is Methanosarcinales.

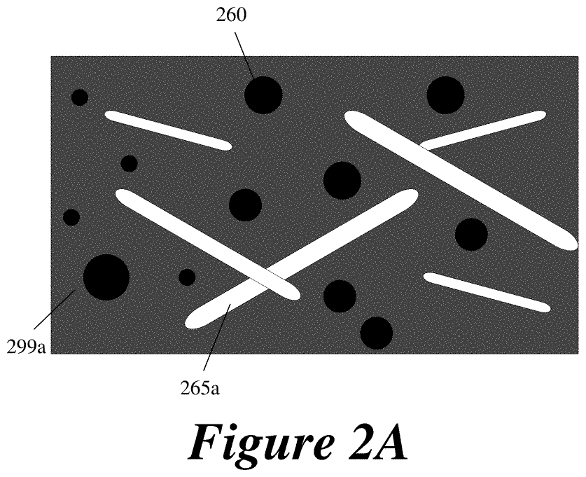

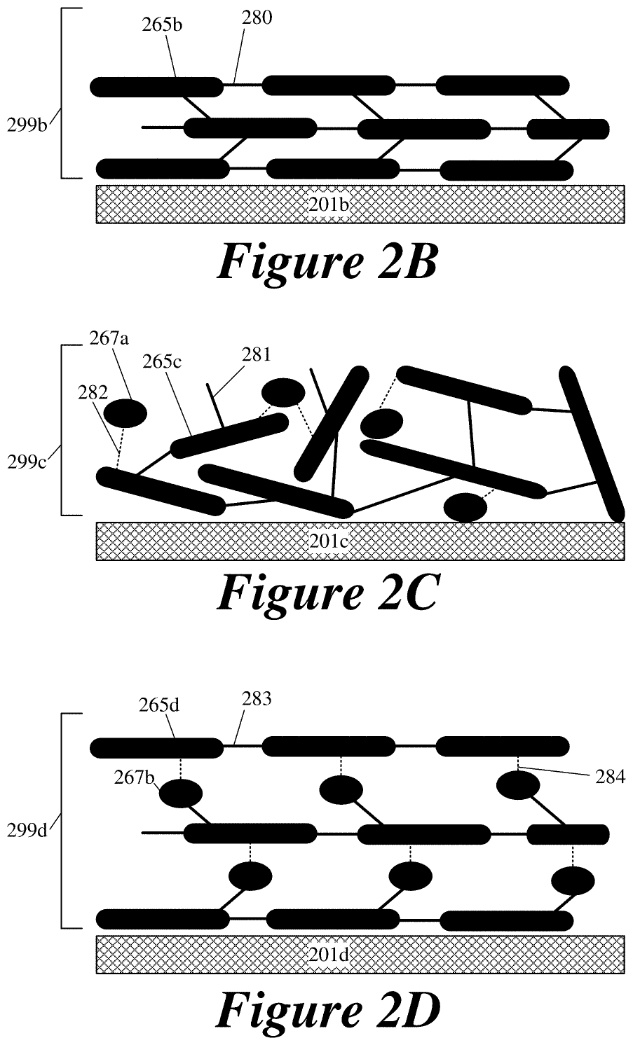

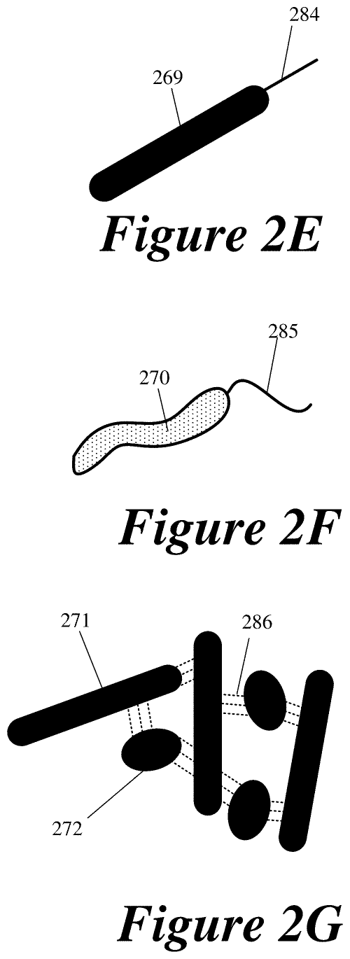

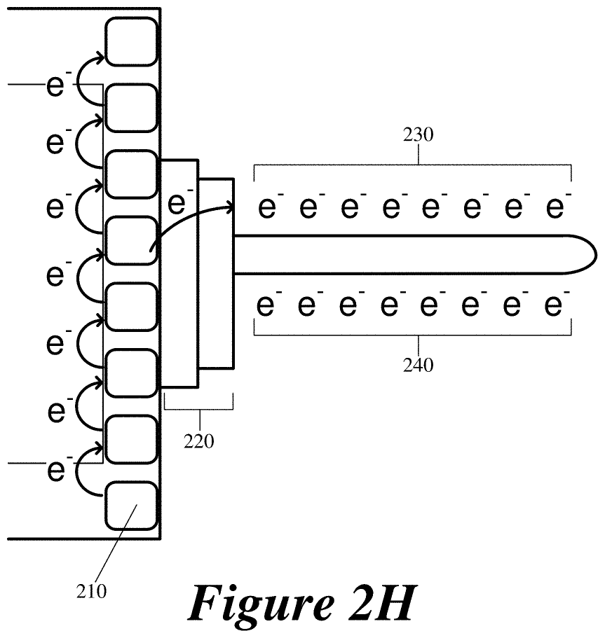

FIG. 2A shows an example of filaments 265a in a biofilm 299a having microbial populations 260.

FIG. 2B shows an example of pili 280, microbe 265b included in a biofilm 299b on a surface 201b. The example shows an example of connectivity between microbes of the same kind on an electrode surface in a biofilm formation where the microbes are arranged in an organized fashion. Pili 280 between microbes can represent connections such as physical attachments, electron sinks, electron transfer, or other material transfer. In various embodiments, pili are conductors, can store charge, can perform redox reactions, or any combination thereof. In some embodiments, pili can provide structure to the biofilm. Other proteins may be present in lieu of or in addition to pili.

FIG. 2C shows an example of a biofilm 299c that includes two types of microbes—first microbe 265c having pili 281 and second microbe 267a having filament 282. This example shows microbes in a generally amorphous random structure, which may be present in the biofilm 299c in some cases. Other proteins including but not limited to pili, flagella, and fimbriae, may be used in lieu of or in addition to pili 281 and filament 282.

FIG. 2D shows an example of a biofilm 299d having two microbes where the microbes are oriented in a way where filament 283 and 284 preferentially connect to a particular side of microbe 265d and 267b. This may be used in embodiments where one microbe generates waste products that can be consumed by a second microbe such that a preferential orientation allows the waste products released from a particular side of the first microbe can be efficiently transferred to the second microbe for consumption. In such embodiments, each of the first microbe and/or each of the second microbe may be generally spaced apart from other microbes of the same species so as not to compete for the same resources. Other proteins including but not limited to pili, flagella, and fimbriae, may be used in lieu of or in addition to filament 283 and 284.

Biofilms may include various types of microbes, some of which have a pilus or pili (such as shown in pili 284 of microbe 269 of FIG. 2E) and some of which have flagella (such as shown in microbe 270 having a flagella with filament 285 of FIG. 2F). One example if a pilus is pilA polymer. Pili and filaments can act as electron sinks, enable electron conductivity, and serve as physical anchoring points to attach to surfaces or neighboring microbes.

In some cases, filaments can provide conductive connections between microbes.

FIG. 2G shows two microbes—first microbe 271 and second microbe 272—where filaments 286 connect the first microbe 271 and second microbe 272. Although three filaments are depicted in FIG. 2G, it will be understood that one or several filaments may connect microbes in different regions of the microbe.

The biofilm allows electron conductivity to move across a population of microbes more efficiently. The electron flow in a cell with microbes that have pili or filament connections may flow more efficiently when the microbes are arranged in a biofilm. An example electron flow diagram is schematically depicted in FIG. 2H. In FIG. 2H, electrons flow from electron transport chain 210 to attachment site 220. Excess electrons are stored in filament 240. When electrons flow from the electron transport chain 210 to attachment site 220, they can flow down filament 230 and be stored in filament 240.

### IX. Position of Biofilm

Biofilms may be positioned in any of various locations within a voltaic cell. The position may depend on the configuration of the voltaic cell itself (see, e.g., different configurations of a voltaic cell in FIGS. 1A and 1B). In general, biofilms may be attached to any surface in a voltaic cell. Examples include electrodes, walls of a vessel, filters, and barriers. In some cases, biofilms may be formed at or near surfaces where positive species are donated, or where positive species are accepted, or where negative species are donated, or where negative species are accepted, or any combination thereof. In some embodiments, the type of biofilm selected for use with an energy conversion cell is selected for its adhesive properties to surfaces of the energy conversion cell.

One or more biofilms may be formed on a surface of an anode, such as biofilm 199a shown on anode 115 of FIG. 1A. Biofilms formed on a surface of an anode may be directly grown on the surface. An anode may be both textured or treated to improve adhesion to the surface. In some embodiments, an adhesion layer is formed on an anode prior to growing the biofilm to enhance attachment of the biofilm onto an anode. In some embodiments, biofilms are formed directly on an anode without texturing, treating, or otherwise modifying the surface of the anode. The composition of the biofilm may be selected depending on the material of the surface of an anode.

One or more biofilms may be formed on a surface of a cathode, such as biofilm 199b on cathode 117 of FIG. 1A. Biofilms formed on a surface of a cathode may be directly grown on the surface. A cathode may be both textured or treated to improve adhesion to the surface. In some embodiments, an adhesion layer is formed on a cathode prior to growing the biofilm to enhance attachment of the biofilm onto a cathode. In some embodiments, biofilms are formed directly on a cathode without texturing, treating, or otherwise modifying the surface of the cathode. The composition of the biofilm may be selected depending on the material of the surface of a cathode. In some embodiments, biologically active biofilms on a surface of an electrode are formed by adding microbes to a film component. For example, microbes may be added directly onto molten hydrogel, which is then poured directly onto a surface of an electrode.

One or more biofilms may be formed on a surface of a permeable barrier and may be exposed to an interior of the energy conversion cell facing with the surface of the biofilm exposed to the microbial population (such as biofilm 199d on the surface of permeable barrier 111 of FIG. 1A) or exposed to a microbial population in another compartment (such as biofilm 199c on permeable barrier 111 exposed to compartment 113 in FIG. 1A). Biofilms formed on a surface of a permeable barrier may be directly on the barrier. A permeable barrier may be both textured or treated to improve adhesion onto the surface of the barrier. In some embodiments, an adhesion layer is formed on a permeable barrier prior to growing the biofilm to enhance attachment of the biofilm onto a permeable barrier. In some embodiments, biofilms are formed directly on a permeable barrier without texturing, treating, or otherwise modifying the surface of the permeable barrier. The composition of the biofilm may be selected depending on the material of the surface of a permeable barrier.

One or more biofilms may be formed on a spacer used within a compartment of an energy conversion cell, such as spacer 143 of FIG. 1B. Biofilms formed on a surface of a spacer may be grown directly on the surface. A spacer may be both textured or treated to improve adhesion on the surface. In some embodiments, an adhesion layer is formed on a spacer prior to growing the biofilm to enhance attachment of the biofilm onto a spacer. In some embodiments, biofilms are formed directly on a spacer without texturing, treating, or otherwise modifying the surface of the spacer. The composition of the biofilm may be selected depending on the material of the surface of a spacer.

One or more biofilms may be formed on any other surface of the energy conversion cell, such as on one or more regions of the bottom of an energy conversion cell, or on an optional cover element of the energy conversion cell, so long as the biofilm can come into contact with one or more microbial populations that may be grown at the bottom of an energy conversion cell or may be floating or suspended in a liquid.

One or more biofilms may be formed on surfaces of the energy conversion cell that are in contact with a microbial population but not in contact with an ionically conductive medium, such as on the anode plate 137 of FIG. 1B facing the microbial population 145. Biofilms formed on this surface may be directly grown on the surface. The surface may be both textured or treated to improve adhesion onto the surface. In some embodiments, an adhesion layer is formed on a surface prior to growing the biofilm to enhance attachment of the biofilm onto a surface. In some embodiments, biofilms are formed directly on a surface without texturing, treating, or otherwise modifying the surface of the surface. The composition of the biofilm may be selected depending on the material of the surface of a surface.

One or more biofilms may be formed on a surface of a liquid that may contain one or more microbial populations. For example, biofilms that are formed on a surface of a liquid may be formed when microbial populations attach or interact with each other to generate a thin matrix of microbes. In some embodiments, biofilms formed on a surface of a liquid are held together by some molecular and/or intercellular bonding.

Biofilms may be formed on an entire surface of a solid surface of the energy conversion cell or may be formed in clusters, or irregularly, or in shaped regions on surfaces of the energy conversion cell. Biofilms may be formed in greater thickness in one surface of an energy conversion cell but have a smaller thickness on another surface of the same energy conversion cell.

Different biofilms or biofilms having different properties may be formed on the same surface of an energy conversion cell, and may be spaced apart, or may be separated, or may be in contact with one another.

One consideration in locating a biofilm and the characteristics of the biofilm is the likelihood of electrode fouling. Electrode fouling occurs when a biofilm blocks or otherwise inactivates a portion of an electrode, rendering it less effective or not effective at all in the blocked portion. For example, a biofilm may block transport of species to and/or from an electrode surface or across an ion permeable separator. Such species may participate in or facilitate an electrochemical reaction taking place at an electrode surface. Examples of such species include positive ions, negative ions, uncharged chemical species, water molecules, and the like. In some implementations, electrode fouling is reduced or avoided by employing biofilms that are receptive to the species in question. As an example, metal reducer microbes may regenerate metal that is electrochemically oxidized at an anode. And, as described below, a biofilms may be limited to certain regions on a surface such as an active surface of an anode or a cathode or a surface of an ion permeable voltaic cell separator. In other words, the biofilm occupies only a fraction of the affected surface.

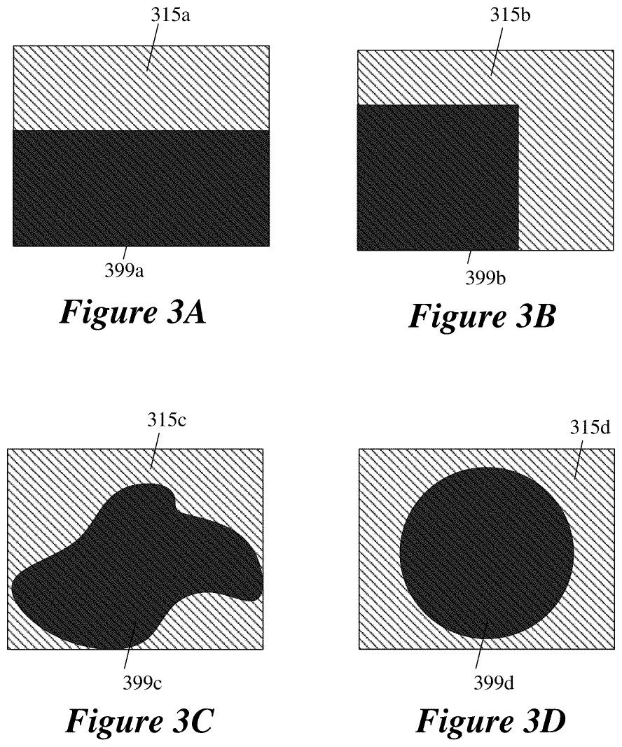

Biofilms may also be present on some areas on the electrode surface, or proximate to an electrode surface, but excluded from other areas for an electrode surface. FIGS. 3A-3D provide examples of biofilms on certain areas of an electrode surface while not on other areas of an electrode surface from a view of the surface of the electrode where the surface in contact with an electrolyte or buffer faces the viewer. it will be understood that while the biofilms depicted in FIGS. 3A-3D are continuous across a surface of the electrode, in some embodiments, biofilms may be formed on various spaced apart regions on the electrode surface. FIG. 3A shows a biofilm 399a on an electrode 315a such that the biofilm occupies a designated half region of the electrode surface. FIG. 3B shows a biofilm 399b on an electrode 315b such that the biofilm occupies a corner region of the electrode surface. FIG. 3C shows a biofilm 399c on an electrode 315c whereby the biofilm 399c assumes a freeform shape on a region of the electrode 315c. FIG. 3D shows a biofilm 399d on an electrode 315d whereby the biofilm 399d assumes an approximate circulate shape on a region of the electrode 315d. It will be understood by a person of skill in the art that biofilm formations and occupation regions on the surface of an electrode are not limited by these examples and may vary depending on the organism(s) in the biofilm, the material of the electrode, and the general formation of the biofilm.

As indicated, the biofilm is provided or grown on a substrate in the voltaic cell. In some embodiments, the substrate is an electrode or cell separator itself. In some embodiments, the substrate is a separate intermediate structure, which may, in some embodiments, be sandwiched between an electrode and the biofilm.

Porosity or stippled surfaces increase surface area and provide more attachment sites for the biofilm to occupy. Materials include nanoparticles (metal, silica), porous hydrogels (agarose, agar, nitrocellulose, methylcellulose, gelatin, alginate), and slimes (polysaccharides).

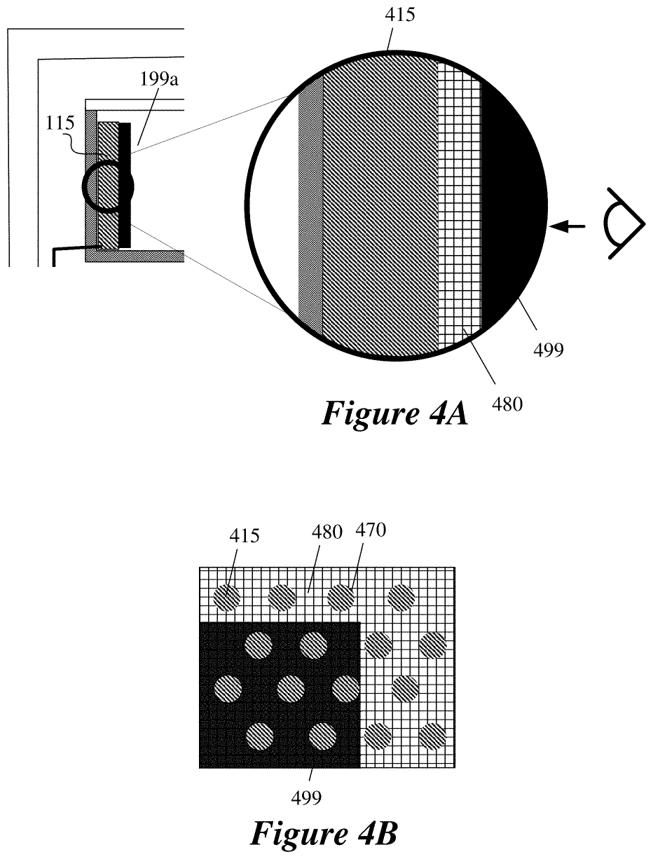

FIG. 4 depicts a cross-sectional view of an example of an electrode surface having an intermediate substrate 480 between an electrode 415 and a biofilm 499. Substrates may be used to help support and immobilize the biofilm while allowing access of the electrolyte to the electrode or cell separator. In some embodiments, the intermediate substrate 480 may be porous such that even while biofilm 499 is adhered to the intermediate substrate 480, openings in the biofilm 499 and/or the intermediate substrate 480 allow access of the electrolyte to the electrode 415.

The intermediate substrate may have any suitable thickness. On the substrate, a biofilm may be grown to any suitable thickness. Porous intermediate substrates may have particular porosity.

An example porous structure is shown in FIG. 4B. This view is from the angle depicted in FIG. 4A. Intermediate substrate 480 is sandwiched between biofilm 499 and electrode 415. The pores 470 provide access through which the electrolyte can contact the electrode 415. In this example, pores 470 span through both the biofilm 499 and electrode 415 but it will be understood that in certain disclosed embodiments, pores may appear only on biofilm 499 or only on electrode 415 or on both biofilm 499 and electrode 415 but may not completely overlap to form a continuous pore between the electrolyte and the electrode.

Where the substrate is not the electrode, the substrate may be a biocompatible polymer, ceramic, or metal.

In some embodiments, where the substrate to which the biofilm attaches is an electrode, the electrochemical role of the electrode may limit its structure and composition. Nevertheless, the electrode may possess certain properties that make compatible with a directly-attached biofilm. For example, the electrode may have a porous structure. Example electrode structures include carbon, metal, or ceramic materials having a morphology that is foam, woven, felt, mesh, perforated, or the like.

### X. Horizontal Electrode Cell Designs

Some microorganisms naturally segregate to the bottom of a container under the influence of gravity. In some cases, these organisms are amotile. In other words, they are not equipped to move about under their own propulsion. Amotile microorganisms often do not contain structures that facilitate propulsion. Examples of such structures in motile organisms include cilia and flagella.

To the extent that amotile microorganisms are needed at a particular location within a bioelectrochemical energy conversion cell, that location may be provided at the bottom of a horizontally oriented cell. For example, if an amotile microorganism is used at the anode of such cell, the anode may be oriented substantially horizontally and placed at the bottom of the cell. In this manner, the organisms preferentially reside next to the electrode where they facilitate the operation of the bioelectrochemical energy conversion cell. Note that organisms may naturally gravitate to the bottom of a cell.

Another function or potential benefit of a horizontally oriented cell is that if some of a liquid electrolyte evaporates (such as by way of contact with forced air at a cathode), the electrodes or at least the electrode at the bottom of the cell will not become exposed, even partially, to air. Among other challenges that result from an electrode being exposed to the ambient is that the surface area that is exposed to the ambient cannot be utilized in electrochemical energy conversion. In some embodiments, a horizontally oriented cell can utilize verticality of a cell to expose biofilms to air while preventing electrodes from being exposed to ambient.

Example amotile microorganism classes include cocci and non-motile bacilli. Specific examples of amotile microorganisms include Staphylococcus, Streptococcus, Bacillus, Pseudomonas, Chlorella, Acetabularia, Desmids and others.

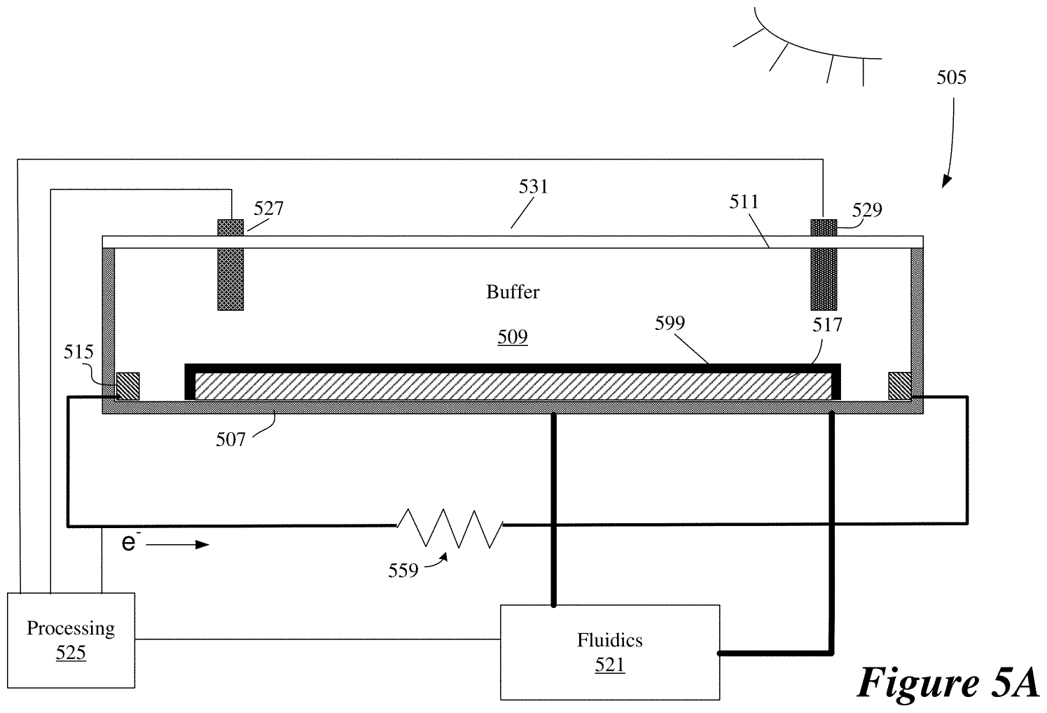

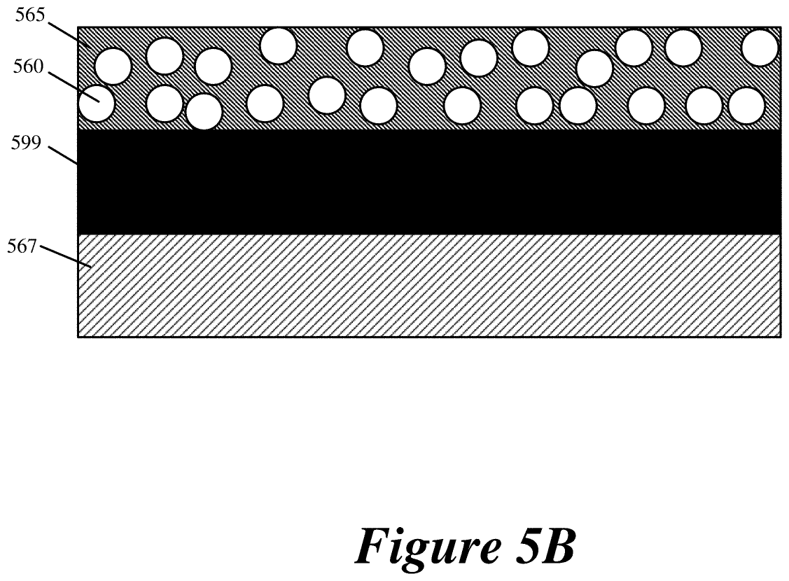

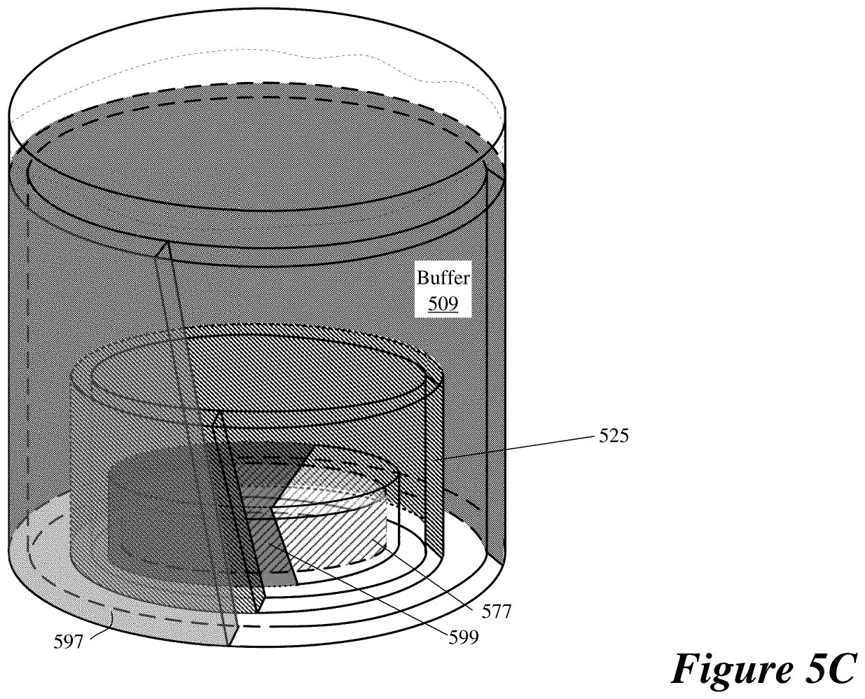

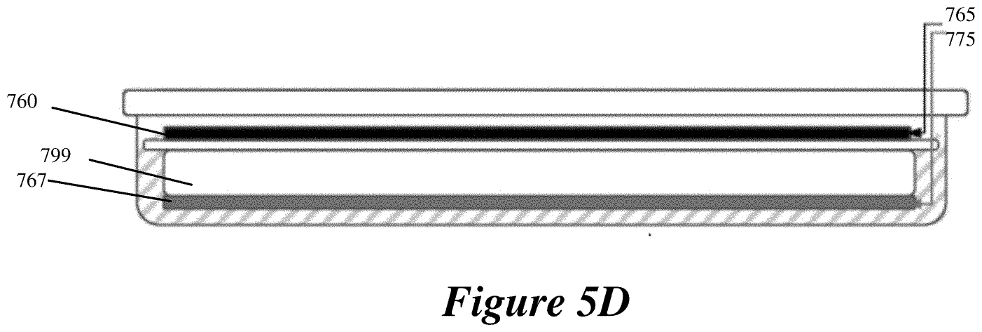

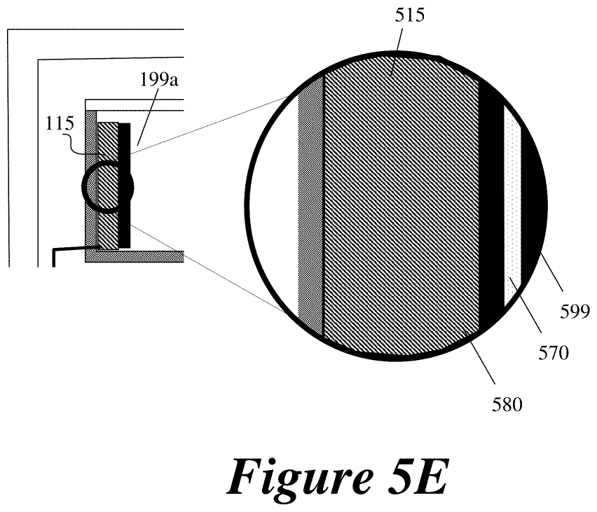

FIG. 5A shows a schematic illustration of a cross-section of a horizontally oriented cell 505. Energy conversion cell 505 includes a containment vessel 407 which holds in its interior 509 a fluid such as a buffer. Cell 505 also includes an optional cover element 531 fitted on top of vessel 507. Element 531 may be transparent to radiation in a wavelength range to which photosynthetic microbial population responds. Cell 505 will include an anode 515 and a cathode 517 electronically separated from one another by, in this example, a biofilm 599. In some embodiments, the biofilm 599 serves as the electrolyte to allow direct contact between microbes and the interface with an electrode. In some embodiments, an ionically conductive medium may separate the anode 515 from the cathode 517. During operation, the microbial population in biofilm 599 may produce electrons that are collected at anode 515. These electrons flow through a load 519 in a circuit coupling cathode 517 and anode 515. Cell 505 may include processing controller 525 and a fluidics system 521 is coupled to the vessel 107 and optionally has separate ports for compartment 509. Cell 505 may also interface with a controller 525 that controls fluidic system 521. Controller 525 may have one or more other functions. For example, it may receive input from various components of the system such as the circuit coupling anode 515, cathode 517, the fluidics system 521, and/or sensors 527 and 529 provided in compartment 509. The sensors 527 and 529 may monitor any one or more relevant operating parameters for cell 505. Example such parameters include temperature, chemical properties (e.g., component concentration and pH), optical properties (e.g., opacity), electrical properties (e.g., ionic conductivity), and the like.

The vessel 507 contains an electrode such as an anode 517 positioned at the bottom of the vessel 507. The anode 517 may be a continuous sheet disposed at the bottom of the vessel 507. The edges of anode 517 may be spatially separated from the counter electrode or cathode 515 by a barrier or other non-conductive medium. The counter electrode (or cathode) 515 may be disposed at various locations. One location of the counter electrode is around the perimeter of the vessel 507. The surrounding counter electrode 515 may itself by horizontally or vertically oriented. So, for example, a copper cathode may be a vertical sheet of copper that lines the perimeter of a cell, which may be a disk or cylinder-shaped enclosure. In another example, the surrounding cathode contains a carbon material and a catalyst that permit reduction of oxygen (e.g., in air). As indicated, the anode 517, which may be an aluminum-containing material, may be horizontally oriented and disposed at the bottom of the vessel 507. For example, if vessel 507 is cylindrical shaped such that the bottom of the vessel 507 is a round, oval, or circle shape, and walls of vessel 507 are vertical, the cathode 515 may be positioned at the bottom of the vessel 507 but also be cylindrical with walls running parallel to walls of the vessel 507.

FIG. 5B is an example of a voltaic cell having a three-layer horizontal design: anode layer 565/biofilm 599 layer/cathode layer 567. Any or all these layers may be in the form of a gel. In some embodiments, a first layer is an anode layer 565. Anode layer 565 may include aluminum powder 560 in an ionically conductive gel. The next layer is a biofilm layer 599, which may include an alginate and/or an agarose. An optional third layer (not shown) contains an ion conducting layer, such an ion-conducting polymer that prevents transport of electrons and may serve to keep the microorganism in place. A final layer is the cathode layer 567. The cathode layer 567 may be a carbon layer, a metal-containing layer such as a copper mesh, a felt layer, or an ionically conductive gel matrix.

In some embodiments, the anode includes an electropositive material (with respect to an electrochemically active material in the cathode) such as a metal. In some cases, the anode includes aluminum, optionally in the form of a powder. The aluminum or other electropositive material may be disposed in a gel, which may be an ion-conducting polymer. In some embodiments, the aluminum or other electropositive material may be distributed evenly or as a gradient in the layer. In some embodiments, the cathode composition includes copper (optionally in the form of a mesh) or carbon (optionally in the form or a powder).

FIG. 5C is an example horizontal configuration of a vessel 597 in a “puck” form in a perspective view which includes cathode layer 525, ion conducting polymer, gel, or liquid (not shown), biofilm 599, and anode layer 577. In some embodiments a liquid buffer 509 may be used. The buffer may be a liquid electrolyte in some embodiments. In some cases, a liquid electrolyte may be used without the ion conducting medium 525. In some embodiments, the biofilm 599 has sufficient gel content to serve as a barrier between anode 577 and cathode 525.

Certain disclosed embodiments can be used to increase surface areas for growth and development of microbes in a biofilm. Leads can be embedded directly into a gel medium or by physically attaching ends to an aluminum anode.

FIG. 5E shows another side view of an example voltaic cell having carbon cloth 760, separated by a layer of sterile gauze 799, on top of gel medium coated aluminum anode 767. Leads (aluminum lead 775 and carbon lead 765) are connected to the carbon cloth/aluminum anode and funneled out through a small opening made. This allows for greater air access for the carbon cloth while utilizing the gel medium as both a trapping mechanism to ensure the growth of microorganisms along the surface of the anode while also providing a structural network for said bacterial species to facilitate and contribute to the voltage output—the desired analytical measurement of bacterial activity. Parameters and features of this voltaic cell that are modulated include voltage output noise reduction, signal dampening, solution/buffer reintroduction, and bacterial incorporation.

A few example horizontal cell formats will now be described.

1. A horizontal design having anode in a central region and a cathode around perimeter may include:
a. an anode optionally includes a metal in which the metal is oxidized;
b. a cathode may be an air reduction electrode; and
c. a biofilm on anode, optionally with phototroph and/or optionally with two or more sublayers.
   In this embodiment, the anode and cathode may be physically separated by their construction, by a physical separator, which may serve as an electrolyte, or by both.
   2. A horizontal design having cathode in middle and anode around perimeter may include:
a. an anode optionally includes a metal in which the metal oxidizes;
b. a cathode may be an air reduction electrode; and
c. a biofilm on anode, optionally with phototroph and/or optionally with two or more sublayers.
   In this embodiment, the anode and cathode may be physically separated by their construction, by a physical separator, which may serve as an electrolyte, or by both.
   Designs 1 and 2 permit a biofilm to have exposure to solar radiation. This is because there is no cathode on top of it to block solar radiation.
   3. A horizontal design having a three-layer stack may include:
a. a cathode on the bottom of the stack;
b. a biofilm as intermediate layer; optionally with phototrophs and/or optionally with two or more sub-layers; and
c. an anode on top of biofilm. The anode may be at least partially transparent to solar radiation to thereby allow radiation to reach phototrophs.

### XI. Biofilm Composition

The composition of the biofilm can include one or more microbes and a matrix that may include water and one or more other materials. In some embodiments, the matrix includes a naturally occurring polymer. In some embodiments, the matrix includes a synthetic polymer. In various embodiments, the matrix includes a hydrate of any one or more materials such as a nucleic acid, a protein, a carbohydrate, or any combination thereof. In naturally occurring matrixes, the component or components of the matrix may be secreted or otherwise generated by the microbe(s) of the biofilm. Example nucleic acid matrix materials include RNA, and DNA. Example protein matrix materials include PilA, fimbriae, proteinases, and metabolic enzymes. Example carbohydrate matrix materials include dextran, and other polysaccharides. Another example is aromatic pigmented molecules.

In some embodiments, a biofilm matrix is provided in the form of a hydrogel. Examples of components that may be employed to form a hydrogel include pectin and alginates (e.g., sodium alginate). In some implementations, a biofilm matrix includes about 5-15% by weight pectin, about 1-8% by weight sodium alginate, and water. In some embodiments, a biofilm matrix includes about 2-7% w/v of pectin using agar compositions having about 2-5% w/v of agar. Biofilm synthesis may also include trapping specific bacterial strains within layers and also introducing growth enhancing materials (such as tryptic soy agar (TSA), HCl, H₃BO₃, etc.) depending on the defined ATCC growth conditions.

Gels can be viscous, semi-solid, or solid. In various embodiments, gels include matrices having a porosity that permits ion flow and nutrient flow but does not permit the migration of microbes out of the gel matrix.

The gel may include one or more additives. Examples of additives include but are not limited to salts (such as sea salt media), DNA (such as salmon sperm DNA), and saline solutions such as phosphate-buffered saline (PBS). One example additive is a protein source. An example protein source may be protein hydrolysates, such as peptone.

In some embodiments, the bacterial-specific synthesis of a gel medium used for certain disclosed embodiments may involve the utilization of sodium alginate powder, TSA, and hydrochloric acid in the synthesis of gel medium for acidophiles.

In some embodiments, the bacterial-specific synthesis of a gel medium used for certain disclosed embodiments may involve the utilization of TSA powder in the synthesis of gel medium for neutrophils.

Below are example compositions of gels:
Example 1. 1.25% agarose+0.5% alginate gel.
Example 2. 0.75% gelatin+0.5% alginate+0.15% pectin gel.
Example 3. 2% agarose gel.
Example 4. 0.5% agarose+1% cellulose+0.25% alginate gel.
Example 5. 1% salmon sperm DNA+1.25% agar gel.
Example 6. 1% salmon sperm DNA+3.5% polyacrylamide gel.
Example 7. 8% hydrogel.
Example 8. 5% w/v polypeptides containing optimal number of zwitterionic amino acids, e.g., Histidines in 1× phosphate-buffered saline (PBS).
Example 9. 5% w/v salmon sperm DNA in 1.25×PBS
Example 10. 5% sea salt media in water
Example 11. 50 mM sodium chloride (NaCl) in Roswell Park Memorial Institute (RPMI) media
Example 12. 50 mM NaCl in Dulbecco's Modified Eagle Medium (DMEM) media
Example 13. Brain heart infusion (BHI) media
Example 14. Lysogyny broth (LB) media
Example 15. 0.2 g Ammonium sulfate ((NH₄)₂SO₄), 0.5 g magnesium (II) sulfate (MgSO₄), 0.25 calcium chloride dihydrate (CaCl₂) 2H₂O), 3.0 g potassium phosphate (KH₂PO₄), 2.0 g of yeast extract in 1.0 L distilled water, adjusted to a final pH of 0.7 using sulfuric acid (H₂SO₄), and autoclaved at 121° C. for 15 minutes.
Example 16. 1.5 g ammonium chloride (NH₄Cl), 0.6 g sodium phosphate (NaH₂PO₄), 0.1 g potassium chloride (KCl), 2.5 g sodium bicarbonate (NaHCO₃), 0.82 g of sodium acetate, 10.0 mL Wolfe's vitamins, 10.0 mL of Wolfe's metals in 976 mL distilled water with 4 mL of 0.025% Resazurin, prepared and dispensed medium without fumarate, anaerobically under 80% nitrogen (N₂) and 20% carbon dioxide (CO₂), autoclaved at 121° C. for 15 minutes in 1 M (16 g/100 mL) sodium fumarate, 2 tubes of 2 mL each.

In some embodiments, individual biofilm layers are thin and to obtain a suitable structure with the addition of bacterial species, medium and other growth factors films are introduced in a step-wise layering fashion.

In some embodiments, components of a matrix are provided in crosslinked form. Crosslinking may in the form of covalent bonds, electrostatic bonds, van der Waals bonds, hydrogen bonds, or any combination thereof.

Typically, biofilms employed herein include some amount of water. The water may be produced by the microbes in the biofilm, added during construction of the voltaic cell, and/or incorporated from an electrolyte or buffer present in the voltaic cell. In some embodiments, water imparts mechanical, biological, and/or electrical properties to the biofilm. For example, ionically conductive water can facilitate ion transport between an electrolyte and an electrode on which the biofilm resides. In some cases, water imbues the biofilm matrix material with adhesion, mechanical strength, or other physical property. In some embodiments, water is present in the biofilm at a concentration of about 60-90% by weight.

A. Multilayer Biofilms

In certain embodiments, a voltaic cell includes a multilayer biofilm, with different layers containing different microorganisms. In some cases, the microorganisms in different layers are complementary to one another. Complementary microbes are described elsewhere herein.

In some embodiments, biofilms are provided as laminates or other multilayer structures. In some cases, a biofilm has two different sublayers, one configured to incorporate one type of microorganism and another sublayer configured to incorporate a different type of microorganism. Such embodiments may be appropriate when two different microorganisms have complementary properties but are incompatible when intimately mixed or in direct contact with one another.

1. Structure of a Multilayer Biofilm

The physical, chemical, and biological properties of the individual layers may vary from layer-to-layer.

To minimize resistance resulting from the biofilm itself, the matrices may have much thinner than normal thicknesses such as less than about 0.5 cm. Furthermore, since this a functional aspect of the fuel cell, fabrication of the sodium alginate biofilm matrix maintains flexibility and composition over a prolonged period such as about 3 to about 4 weeks. In some embodiments, the addition of DMEM+CaCl₂ over a 30-minute period into 2% sodium alginate/pectin (1:1) solution results in cross-linking.

Compositions will vary primarily in the additional growth factors for strain specific microbial growth. Some examples include but are not limited to addition of 10 mL of 0.1 M HCl and DMEM for certain microbes, and addition of Van Niels Yeast agar for a Rhodospirillum rubrum microbe.

Biofilms may be in direct physical contact over a large horizontal surface area. Stacking/organization of biofilms depends on a multi-organism relationship used for the cell. One example involves a photosynthetic bacterial biofilm on top of a conductive filamentous biofilm.

In some embodiments, one of the microorganisms is photosynthetic and the other is not photosynthetic. In such cases, the photosynthetic organism may be placed closer to a light source. In some implementations, this means that the photosynthetic microorganism should be in an upper layer of a multilayer biofilm stack.

Thicknesses and/or composition of each layer of a biofilm may vary from layer to layer.

2. Porosity of Multi-Layer Biofilms

In some cases, the sublayers are separately fabricated and different microorganisms are separately incorporated in the layer. In other embodiments, one sublayer may have a pore size range that is different from pore size range in another sublayer. In some cases, one sublayer has pore sizes that accommodates the microbes themselves, while another sublayer has pore sizes that accommodate vesicles of the microbes, i.e. the other sublayer has smaller pore sizes than the first sublayer. A variety of pore sizes may assist in ionic flow as well as stability.

Microbes in a biofilm may be positioned or distributed on any of various regions of the biofilm. Examples of such regions include portions of the two-dimensional surface of the substrate on which the biofilm resides, embedded within a matrix within the biofilm, between continuous regions of biofilms, or sandwiched or suspended in liquid between two or more biofilms. In some embodiments, the biofilm includes one or more layers. In some embodiments, microbes are preferentially located in a subset of the layers. For example, microbes may be preferentially located in one of the one or more layers. In some embodiments, microbes are located in two or more layers. For example, FIG. 5 shows an example of microbe layer 570 within the biofilm 599. While one layer is shown, it will be understood that two or more layers may also be present. In some embodiments, layers vary in number or size as a function of position across the surface of the entire biofilm.

Microbes in the biofilm are characterized by density measured in microbes/cm³.

3. Methods of Fabricating a Multilayer Stack

In some implementations, the individual layers are fabricated separately and then assembled. In some implementations, a first layer, such as a layer closest to a vessel wall or an electrode, is fabricated in place. Then a second and subsequent layers are fabricated on the first layer. In certain embodiments, one or more layers of a multilayer biofilm is fabricated using a microorganism enclosure as described elsewhere herein.

Each layer is individually fabricated in situ. In some embodiments, post-congealing stacking may not be used due to structural concerns. Once a matrix gel is synthesized, the molten solution is poured directly over the prior layer in particular process conditions. For example, the solution is an acidic solution. In some embodiments, the solution is an alkaline solution. Bacterial layer trapping occurs during the cooling phase of the gel prior to molding. Sonication may be used to assist in full dispersion of material components added. Sonication is not used in the presence of bacterial strains.

B. Biofilm Microbial Composition

Biofilms may include microbes of various types. Example classes of microbes include anaerobic, aerobic, and facultatively anaerobic microbes.

Biofilms may include combinations of complementary microbes. Two microbes can be complementary if the combination of the two microbes has particular complementary characteristics. For example, one example of a complementary characteristic is a microbe that is sulfur oxidizing and a microbe that is sulfur reducing.

1. Types of Microbial Complementarily

In some cases, the complementarity is based on metabolic pathways, such that the metabolic pathway of one microorganism generates a product that is consumed by a different microorganism. In some cases, the complementarity is based on one microorganism's production and maintenance of a beneficial environment for a different microorganism. The beneficial environment may be a particular range of pH values or other conditions described herein. In some cases, the multiple microorganisms produce an environment in which multiple organisms thrive.

In certain embodiments, microorganisms in at least one of the layers generates electrons or otherwise strongly participates in the bioelectrochemical energy conversion process.

Complementary microbes that may advantageously utilize a biofilm structure are described above with respect to Section VIII.

### XII. Biofilm Properties

1. Selection of Microbial Organisms

Selection of biofilm types may depend on the bioelectrochemical cell and its purpose. Another factor that may determine the selection of microbes used in a biofilm include but are not limited to the microbe growth conditions, the surface that the biofilm is grown on, the configuration of the energy conversion cell, and the metabolic pathways for each microbe in the bioelectrochemical cell.

2. Electrical Properties

Biofilms may exhibit various electrical properties. In some embodiments, biofilms possess a net electrical charge on an associated surface. An electrically charged biofilm can facilitate attraction and/or transport of oppositely charged mobile species such as ions in an electrolyte. In some embodiments, a biofilm's matrix includes charged components. In some embodiments, a naturally occurring charged matrix protein or other polymer has a net positive electrical charge owing to positively charged monomers. Example charged polymers include lysine-rich, histidine-rich, and/or arginine-rich proteins or peptides. Examples of negatively charge matrix components include proteins or other polymers rich in negatively charged monomers such as aspartic acid and/or glutamic acid.

3. Mechanical Properties

Biofilms possess mechanical properties, some of which may influence the biofilms' role in a biochemical voltaic cell. For example, in some embodiments, biofilms in a bioelectrochemical energy conversion cell may strongly adhere to a substrate surface. The adhesive force may be measured by a standard test for coating adhesion such as a scratch test.

The dimension and other physical features of the biofilm may also depend on the microbes, matrix, and other components of the biofilm. The thickness of layers of each of biofilm layer in a multi-layer structure may be at least about 0.5 cm in thickness. In some embodiments, a biofilm has a particular surface roughness Surface roughness refers to roughness measured on the exposed surface in contact with an electrolyte. In some embodiments, a biofilm's thickness is about 10-300 micrometers.

4. Porosity

The biofilm may also have particular topography and/or porosity. Porous biofilms may have pores or openings of a particular maximum cross-sectional dimension. In certain embodiments, pores in a biofilm matrix have an average or mean pore size of about 10 nm to 10 μm. Functionally, a biofilm's pore size may correspond to a size or size range of microorganisms incorporated in the biofilm. In some embodiments, the pore size corresponds to sizes of vesicles produced by microorganisms in the biofilm. In certain embodiments, pore sizes for accommodating microorganisms may be about 1 to 100 micrometers on average. In certain embodiments, pore sizes for accommodating microorganism vesicles may be about 10 to 100 nanometers on average.

### XIII. Methods of Producing Biofilms

Various methods may be used for producing biofilms. Biofilms may be fabricated on or using a gel-like substance. Gel-like substances include alginate, agar, agarose, pectins, gelatin, and Sephadex. In one example, a biofilm is formed by fabricating a hydrogel using a hydrogel-forming molecule. For example, algae culture and sodium alginate may be homogenized and mixed when in wet form, and then filtered, and collected to form an alginate hydrogel. The hydrogel may be rinsed and filtered to form biofilm pads. In some embodiments, the biofilm pads have microbes trapped within them. In some embodiments, the biofilm pads form structures upon which microbes can grow. Alternatives to alginate include but are not limited to gelatin and pectin. In some embodiments, mixtures of alginate and pectin may be used. For example, a biofilm pad may be formed having between about 3% and about 15% pectin, and about 3% to about 7% sodium alginate. In some embodiments, the pad may be coated on an aluminum anode. In some embodiments, the homogenized liquid mixture can be used to deposit into separate molds to form transportable biofilm pads. Biofilms may be applied directly on surfaces of a bioelectrochemical voltaic cell side by side to one another or in layers one on top of another or a combination thereof. In some embodiments, microbes may be applied to biofilm pads using aerosol suspension such as by powder coating.

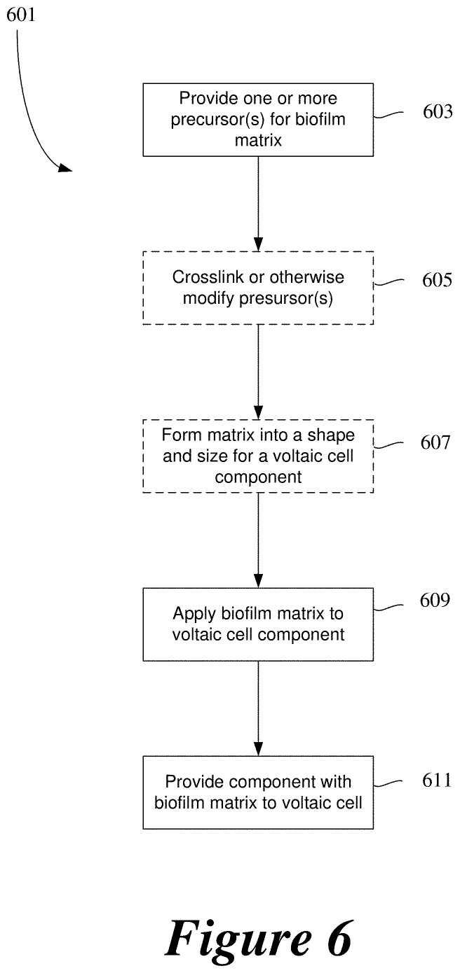

FIG. 6 presents a process flow 601 that includes multiple steps that may be employed to produce biofilms for use in voltaic cells. The depicted process begins with an operation 603 in which one or more precursor or component materials are provided for a biofilm matrix. In some embodiments, precursor(s) are polymeric and/or gel-forming materials. In some embodiments, a precursor has properties that cause it to form a porous matrix.

In some embodiments, the process modifies a chemical or physical-chemical property of one or more precursors to form a biofilm matrix. In FIG. 6, this is depicted by an optional operation 605. In some embodiments, the modification involves reacting the one or more polymer precursors to form a cross-linked matrix. The cross-linking may be via electrostatic forces such as ionic or van der Waals forces, or it may be via covalent bonds. In some embodiments, operation 605 involves changing a morphological property such as porosity or surface roughness. In some embodiments, operation 605 involves changing a physical property such as wettability and/or adhesion. In some embodiments, operation 605 involves changing a biological property such as compatibility (or lack of compatibility) with one or more types of microorganism. As an example, a microorganism nutrient may be incorporated in the matrix. The modification may involve applying a physical effect such as heat, pressure (or vacuum), or irradiation (e.g., UV irradiation). In one embodiment, the modification involves first heating the precursor(s) to a temperature of about 80-110° C. and then cooling the composition to a temperature of about 20-50° C. Such a heating and cooling operation may serve to cross-link certain precursors such as hydrogel precursors. Note that in some implementations, operation 605 is not performed because, e.g., the precursor(s) is/are provided in a form that requires no modification to perform the role of a biofilm.

After the biofilm matrix components are provided and optionally modified, process 601 optionally forms the matrix into a biofilm shape that can be used in the voltaic cell. See operation 607. This operation is optional as certain embodiments form the matrix directly on a voltaic cell component without first forming a biofilm matrix component(s) into a suitable form. When operation 607 is performed, it may involve forming the biofilm matrix via melt processing, solution processing, or solid-state processing. In some embodiments, the biofilm shape is formed by molding, spraying the biofilm on a substrate, pouring molten or solubilized biofilm matrix onto a substrate, extruding biofilm into a sheet or other shape, compressing solid biofilm matrix, and the like.

Process 601 applies a biofilm matrix to a structural component that is used in a voltaic cell. See operation 609. Examples of such structural components are described elsewhere herein. Electrodes and electrolyte separators are examples of structural components that may be used. Applying a biofilm matrix to a structural component may involve adhering the biofilm matrix to a surface of the component. Adhering may be accomplished by, e.g., applying an adhesive to the biofilm and/or the component surface, contacting molten or solubilized biofilm matrix with the component surface, etc. In some embodiments, a preformed biofilm matrix (e.g., a matrix resulting from optional forming operation 607) is first aligned with the structural component and then adhered.

In some embodiments, operation 607 and/or 609 is performed in a manner that produces a laminate or other multi-layer structure having two or more biofilm matrix sublayers. As explained elsewhere, such sublayers may have different morphologies, chemical compositions, biological compositions, house different types of microorganisms, etc.

In process 601, the final depicted operation is installing or otherwise providing the component with its biofilm matrix to the voltaic cell where, during normal operation, microorganisms in the biofilm will facilitate electrochemical energy conversion to produce electricity. See operation 611. In the case where the component is an electrode or electrolyte separator, the electrode or separator, along with its biofilm matrix, is installed in a vessel defining the boundaries of the voltaic cell.

The depicted process 601 does not illustrate the process of incorporating a microorganism into biofilm matrix. In general, a microorganism may be incorporated at any point in the process, so long as a subsequent operation in the process does not kill or substantially injure the microorganisms.

In some embodiments, one or more microorganisms are provided with the precursor(s) in operation 603. In some embodiments, one or more microorganisms are provided during the matrix modification operation 605. For example, a polymer mixture may be spiked with microorganisms while cooling from a heat or radiation induced cross-linking operation. In some embodiments, one or more microorganisms are provided during the biofilm matrix forming operation 607. In some embodiments, one or more microorganisms are incorporated into the matrix when the matrix is applied to the component in operation 609. In some embodiments, one or more microorganisms are provided to the matrix while or after the component is installed in the voltaic cell in operation 611. As an example, after a matrix-containing component is installed in a voltaic cell, microorganisms are incorporated into the matrix by contacting the matrix with a buffer or other medium that contains the microorganisms. Contact may be achieved by flowing the medium onto the component, spraying the medium onto the component, etc.

In some embodiments, microorganisms are applied in two or more phases. For example, some microorganisms may be applied during operation 605 and some other microorganisms may be applied during operation 611.

Biofilms may include a material that increases surface area for microbes to be in contact with surfaces of the bioelectrochemical voltaic cell. For example, a cell may utilize carbon paint on certain surfaces to increase surface area for microbes to grow biofilms on. Carbon paint is a relatively low resistance material but allows for high surface area for biofilms to grow on. Biofilms may be grown on surfaces that have low resistance relative to internal resistance of the battery.

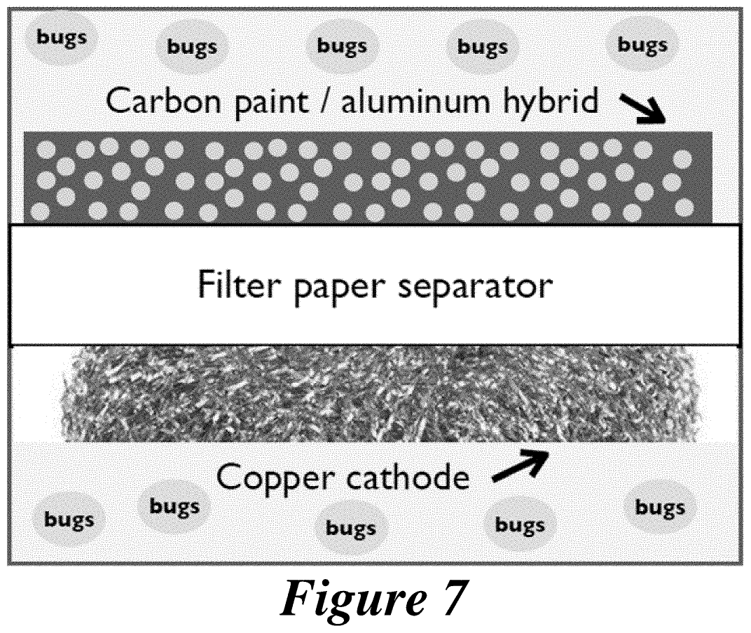

One example is provided in FIG. 7. FIG. 7 shows a structure where aluminum-based paint and conductive carbon paint are mixed to form an anode where the carbon paint includes particles of aluminum within it. In this example, the carbon paint and aluminum hybrid acts as an anode with a filter paper separate between it and a copper cathode. Although copper is shown in this example, it will be understood that other materials and other metals may be used for the cathode material. As indicated, bugs or microbes may be in contact with the cathode and/or the carbon/aluminum hybrid material, and in some embodiments, could be between the carbon/aluminum hybrid and the filter paper separator, or may be between the cathode and the filter paper separator. In some embodiments, the microbes may be in solution before, during, or after biofilm formation.

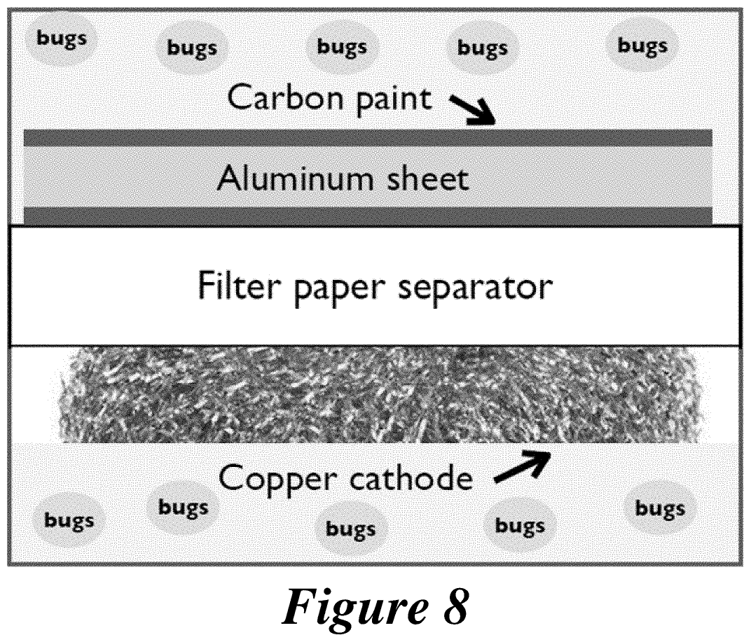

FIG. 8 shows another example where the carbon paint is used, but instead of mixing it with aluminum-based paint as in FIG. 7, in this example, carbon paint is coated on both sides of an aluminum sheet and, like FIG. 7, is separated from a copper cathode by a filter paper separator. Although both sides of the aluminum sheet are coated with carbon paint, it will be understood that in some instances, only one side of the aluminum sheet, such as only the side exposed to microbes, is coated. Without being bound by a particular theory, it is believed that a cell like that depicted in FIG. 8 may be utilized for lower current density embodiments. Both embodiments and variations thereof may be suitable for forming biofilms thereon and for scaling to larger industrial size tools for generating steady power.

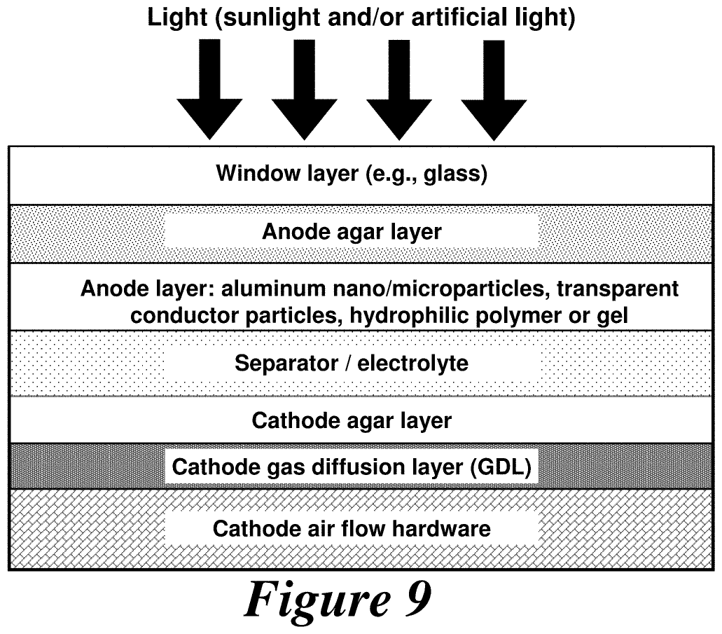

FIG. 9 shows another example where a horizontally oriented voltaic cell is depicted, including a window layer (such as glass) that is exposed to sunlight or artificial light. Underlying the window layer is an anode agar layer; an anode layer, which may be aluminum nano or microparticles, transparent conductor particles, hydrophilic polymers or gels; a separator or electrolyte layer; a cathode agar layer; a cathode gas diffusion layer (GDL); and cathode air flow hardware. Layers may be rearranged and materials for each layer may vary depending on the particular application and microbe(s) being used. Microorganisms may be present in one or more of the anode agar layer, the anode layer, the separator, and the cathode agar layer.

### XIV. Methods of Maintaining Biofilms

Various methods may be used for maintaining biofilms during normal operation of the bioelectrochemical energy conversion cell to ensure a working supply of non-microbe building blocks of a biofilm.

In various embodiments, biofilms formed on electrodes such as those described in FIGS. 7 and 8 and variations thereof may be utilized after rehydrating the surfaces. In various embodiments, bioelectrochemical voltaic cells described herein are self-sustaining.

In some embodiments, certain acidophilic energy-generating microbes may be used as biofilms. As the microbe alkalinizes its environment and stops being metabolically active, adding acid into the system rejuvenates the microbe and maintains its function.

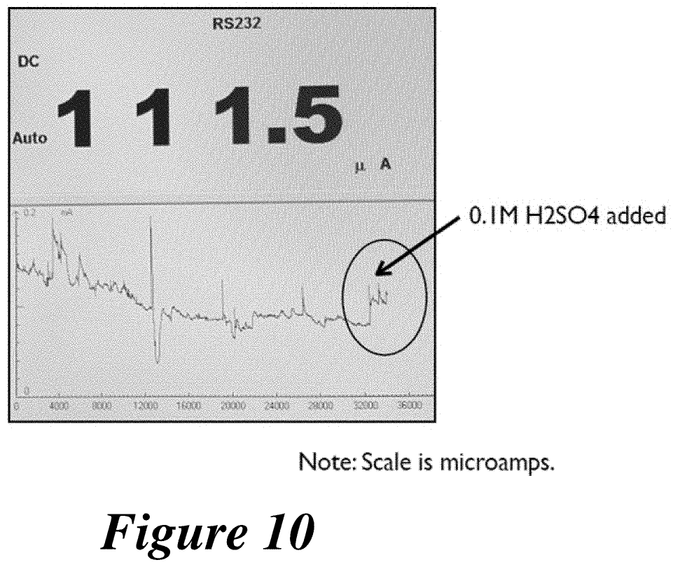

FIG. 10 shows results from an experiment measuring the electrical energy of an acidophilic energy-generating microbe over time. When acid was reintroduced as shown, a spike in current appeared, which suggests maintenance of an acidophilic energy-generating microbe can be revitalized by maintaining pH within the cell, which may be performed by introducing an acid or by utilizing a suitable buffer for the microbe.

### XV. Features of the Vessel for Voltaic Cell

In one embodiment, an important function of a voltaic cell is to harvest photons and harness excited electrons contained within the cell to generate electrical current using photosynthetic microbe and photosynthetic microbial membrane populations. The cell may include a leak proof vessel or housing for the microbial energy conversion cell medium and microbial population. In some embodiments, the microbial energy conversion cell additionally includes electrodes, sensors, semi-permeable barriers, ionic conductive material, wires and the like.

Typically, a cell that utilizes photosynthetic microbes should be designed to accept external radiation and convert the energy therein to excited electrons of the light harvesting antennae of microbial membranes and to provide conductive material for the harnessing of resultant high energy electrons generated by the electron transport chain within each membrane of a microbe.

Microbial energy conversion cells of the disclosed embodiments can have full access to the environment and can be constructed in a manner to enable photon conversion at temperatures ranging from −20° C. to 65° C. and weather ranging from complete sun to cloud or fog cover. Microbial energy conversion cells of the disclosed embodiments can also be portable and can have variable access to the environment, as determined by the user.

In certain embodiments, vessels can withstand high temperatures (e.g., about 50° C. or greater) and internal pressures (above atmospheric) of about 50 Pa to about 10 kPa; of about 500 Pa to about 3 kPa; of about 800 Pa to about 1.5 kPa. Note that some embodiments employ microbes whose natural habitat is a high pressure environment such as a deep sea vent.

In some embodiments, the cell is a closed system with no flow of fresh buffer or other solution into the system and no exposure to atmospheric gas exchange. In other embodiments, it is a semi-closed system containing, for example, a system of tubing, valves and ports to allow the inflow of fresh buffer, regulating elements, fresh microbial antennae population and/or atmospheric gases into the system. The ports of which contain 0.22 μm filters to prevent contamination of the system by atmospheric microbial contaminants. In other aspects, the ports contain 0.45 μm filters to prevent contamination of the system by larger atmospheric microbial contaminants.

In yet other embodiments, the cell is an open system with full access to the environment. In some cases, the open system is a body of water, such as a pond, lake, river, reservoir, stream or other open body of water. The open system may also contain a system of tubing, valves and ports to allow the circulation of endogenous fresh microbial antennae population into the open system microbial energy conversion cell.

An immersible open system may have an anode and a cathode and a semipermeable barrier that permits ionic conduction but blocks transport of microbes. The barrier could be an anti-microbial coating (e.g., silver). Conductive electrical leads from the anode and cathode may be present. The system may include components that are part of a circuit, part of a mechanical support structure, or both.

Vessels bounding the voltaic cell and may be made from any of a number of materials including, as examples, a polymer such as polyethylene, polypropylene, or polyurethane, glass, metal, or a combination thereof. In various embodiments, the vessel material is a gas- and liquid-impermeable material.

A vessel may contain a multilayered unit containing an outermost layer and one or more inner layers. The outer layer may contain clear plastic, glass, metal or other material to provide protection against the environment. In some embodiments, vessel has an outermost layer that permits passage of various spectral wavelengths of electromagnetic radiation. In some embodiments, the outermost layer may be permeable to most spectral wavelengths of light energy. In some embodiments, a portion of the vessel may contain an outermost layer that may be impermeable to most spectral wavelengths of light energy and a second portion of the vessel that contains an outermost layer that may be permeable to most spectral wavelengths of light energy.

In some embodiments, the vessel defining the outer boundary of the microbial energy conversion cell is rigid. The rigid enclosures can contain glass or polymer with a stiffness of >about 1.3 GPa, and having a shape resembling a cube, cuboid, sphere, column, cylinder, cone, frustum, pyramid or prism. The wall thickness of the enclosure can span the range of about 1 mm to 20 cm. Preferred is an enclosure with a wall thickness ranging from about 5 mm to 25 mm.

The vessel volume, shape, and dimensions may be chosen to complement the overall structure of the energy conversion system in which it resides. In some embodiments, the vessel volume may be in the range of about 0.0000001 m³ to about 3 m³; from about 0.000001 m³ to about 2 m³; from about 0.0001 m³ to about 1.5 m³; from about 0.01 m³ to about 1 m³; or from about 0.1 m³ to about 0.5 m³.

The vessel may be manufactured by standard methods including part molding, injection molding, extrusion, laser etching, gluing, soldering caulking, and other suitable techniques.

In some embodiments, the vessel defining the outer boundary of the microbial energy conversion cell is a frame having electrically insulating properties. In some aspects of the disclosure, the framed enclosure has thermal insulating properties and is foam-filled. Frames of the disclosed embodiments include fiberglass, aluminum, stainless steel, graphite, polycarbonate, carbon fiber, polystyrene, polyethylene, polyethylene, polyvinylchloride, polytetrafluoroethylene, polychlorotrifluoroethylene, polyethylene terephthalate, meta-aramid polymer, or copolyamide.

In other embodiments, the enclosure defining the outer boundary of the microbial energy conversion cell is flexible. Examples of flexible enclosures include one or more clear polymer with a stiffness of less than about 1.2 GPa and having an amorphous shape or having a shape resembling a cube, cuboid, sphere, column, cylinder, cone, frustum, pyramid or prism. Examples of suitable polymers include polypropylene, polystyrene, polyethylene, polyvinylchloride, polytetrafluoroethylene, polychlorotrifluoroethylene, polyethylene terephthalate, meta-aramid polymer, or copolyamide. The wall thickness of the enclosure can span, for example the range of about 0.5 mm to 25 mm. In some embodiments, the enclosure has a wall thickness ranging from about 1 mm to 10 mm.

In some embodiments, a window is included in the microbial energy conversion cell for photon energy penetration into the energy conversion cell. The window may be transmissive to light at a range between about 100 nm and 1060 nm and can contain glass, crystalline composites and polymers such as poly(3,4-ethylenedioxythiophene), poly(3,4-ethylenedioxythiophene), poly(styrene sulfonate), poly(4,4-dioctylcyclopentadithiophene), or other transparent polymers. In certain embodiments, the windows can be about 1 mm to 30 cm thick. In some cases, the windows range from about 5 mm to 25 mm in thickness.

In some embodiments, gaskets or seals are included in the microbial energy conversion cell can be used to provide a leak-proof seal between the frame of the cell and a window and between the enclosure of a cell and a port or tubing. Suitable gaskets or seals may contain UV-resistant silicone, cure-in-place resin, ethylene-propylenediene, closed cell nitrile, or other UV-resistant gasket or sealant.

In one example, a containment chamber includes a glass panel juxtaposed to a UV-resistant gasket fitted onto a contiguous injection-molded polymeric sidewall and backing unit. The contiguous injection-molded polymeric sidewall and backing unit having: an inlet port and/or an outlet port for fluid and/or 0.22 μm filter gas-exchange port and fitted electron flow conduit plate connected to electrical wiring for the focused flow of direct current into an alternate current converter of a solar panel.

In another example, a vessel shape is a hollow polymer tube. In some embodiments, the vessel is shaped as a cylinder; a rectangle; a square; a sphere; a columnar object; or a planar object. In some embodiments, the vessel is a designed as fermenter; a growth chamber or other cell culture apparatus.

In certain embodiments, the cell system includes a housing frame, a light-conversion system adapter, AC adapter and electrical cord. In some embodiments, the system can house an array of light-conversion systems. In other embodiments, the solar panel can be fabricated in a manner such that the housing frame can enable the removal and replacement of a light-conversion system. Cells as disclosed herein can serve a functional role and can be used in a solar panel to provide electrical current to a dedicated external electrical load (e.g., a grid) while other aspects of the disclosure use a portable photovoltaic cell to provide electrical current to a device.

In some embodiments, the cell housing is a rigid system and provides a structural role in addition to a radiant energy acceptance role.

In certain embodiments, the voltaic cell can be used in a structural and functional role and can be used in an automobile and airplane as a hood, roof, sunroof, moonroof, trunk, frame, wing, window or other. Additionally, the cell can be used in a building as a wall, wall curtain, roof, window, door, walkway, patio, drive way, deck, fence or other.

In other embodiments, the cell housing is a flexible system that may provide a physical role in addition to an energy conversion role. Examples of use for a flexible microbial energy conversion cell are: retractable elements such as awnings, sails, covers, tarps, cloaks, capes; and foldable elements such as blankets, visors, umbrellas, parasols, fans and clothing.

The cell may also include electron siphons. Examples of electron siphons are discussed in U.S. Pat. No. 10,090,113, issued on Oct. 2, 2018, which is herein incorporated by reference in its entirety for purposes of providing examples of electron siphons.

### XVI. Conclusion

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

1. A voltaic cell comprising:
(a) an anode for receiving electrons and providing electrons to an external circuit or load;
(b) a cathode for donating electrons to an electrochemical reaction;
(c) a biofilm comprising a microbe, the biofilm in electrical contact with the anode or cathode;
(d) a buffer comprising an ionically conductive medium in contact with the anode and cathode; and
(e) a vessel at least partially containing the biofilm and the buffer.

2. The voltaic cell of claim 1, further comprising an ion permeable and electron donor impermeable barrier separating the buffer into an anode compartment and a cathode compartment, thereby preventing an electron donor population from contacting the cathode, wherein the ionically conductive medium comprises the electron donor population.

3. The voltaic cell of claim 1, wherein the biofilm is in contact with at least one of the anode and the cathode.

4. The voltaic cell of claim 2, wherein the biofilm is in contact with at least one of the anode, the cathode, and the ion permeable and electron donor impermeable barrier.

5. The voltaic cell of claim 1, wherein the biofilm comprises two or more microbes.

6. The voltaic cell of claim 1, wherein the biofilm is formed on a substrate in the voltaic cell.

7. The voltaic cell of claim 6, wherein the substrate is either the anode or the cathode.

8. The voltaic cell of claim 6, wherein the substrate contacts a surface of the anode or the cathode.

9. The voltaic cell of claim 1, wherein the biofilm comprises positively charged moieties.

10. The voltaic cell of claim 1, wherein the biofilm comprises negatively charged moieties.

11. The voltaic cell of claim 1, wherein the biofilm comprises synthetic moieties.

12. The voltaic cell of claim 1, wherein the biofilm comprises non-synthetic moieties.

13. The voltaic cell of claim 1, wherein the biofilm comprises one or more filamentous appendages.

14. The voltaic cell of claim 1, wherein the biofilm comprises one or more microbe classes selected from the group consisting of anaerobic, aerobic, and facultatively anaerobic microbes.

15. The voltaic cell of claim 1, wherein the biofilm comprises a sulfur oxidizing microbe and a sulfur reducing microbe.

16. The voltaic cell of claim 1, wherein the biofilm comprises one or more microbes selected from the group consisting of Rhodoferax ferrireducens, Lactobacillus acidophilus, Rhodospirillum rubrum, Desulfovibrio desulfuricans subsp. desulfuricans, Peptostreptococcus anaerobius, Rhodospirillum centenum, Catonella morbi, Lachnospiraceae sp., Photobacterium leiognathi, Allochromatium vinosum, Lactobacillus casei, Fusobacterium nucleatum subsp. polymorphum, Helcococcus kunzii, Cutibacterium acnes, Rhodospirillum rubrum, Helcococcus kunzii, Allochromatium vinosum, and Ferrovum myxofaciens.

17. The voltaic cell of claim 1, wherein the biofilm comprises a matrix comprising a natural polymer, a synthetic polymer, a hydrate of DNA, a hydrate of a protein, or a hydrate of a carbohydrate.

18. The voltaic cell of claim 2, wherein the ion permeable and electron donor impermeable barrier is electronically conductive.

19. The voltaic cell of claim 2, wherein the ion permeable and electron donor impermeable barrier contacts the anode.

20. The voltaic cell of claim 1, further comprising a current collector in electrical communication with the anode.

21. The voltaic cell of claim 1, wherein the ionically conductive medium comprises a first species of microbe and a second species of microbe, and the first species of microbe and/or the second species of microbe comprises light harvesting antennae.

22. The voltaic cell of claim 21, wherein the first species of microbe is excited by electromagnetic radiation in a first band, and wherein at least one other species of microbe in the buffer is excited by electromagnetic radiation in a second band, wherein the first band and the second band do not substantially overlap.

23. The voltaic cell of claim 1, wherein the ionically conductive medium comprises a first species of microbe and a second species of microbe, and the first species of microbe comprises a phototrophic or chemo-trophic microbe.

24. The voltaic cell of claim 1, wherein the ionically conductive medium comprises a first species of microbe and a second species of microbe, and the first species of microbe is a chemotroph and the second species of microbe is a phototroph.

25. The voltaic cell of claim 1, wherein the ionically conductive medium comprises a first species of microbe having a first primary metabolic pathway and a second species of microbe having a second primary metabolic pathway, and the first primary metabolic pathway oxidizes a compound containing carbon, nitrogen, phosphorous, or sulfur forming an oxidized compound, and the second primary metabolic pathway reduces the oxidized compound produced the first primary metabolic pathway.

26. The voltaic cell of claim 1, wherein the ionically conductive medium comprises a first species of microbe and the first species of microbe has pili, fibrils, flagella, and/or a filamentous shape.

27. The voltaic cell of claim 1, wherein the ionically conductive medium comprises a first species of microbe and the first species of microbe has a plurality of metabolic pathways.

28. The voltaic cell of claim 1, wherein the ionically conductive medium comprises a first species of microbe and the first species of microbe is a naturally occurring microbial species.

29. The voltaic cell of claim 1, wherein the ionically conductive medium comprises a first species of microbe having a first primary metabolic pathway and a second species of microbe having a second primary metabolic pathway and the first primary metabolic pathway and the second primary metabolic pathway each participate in cellular respiration.

30. (canceled)

31. A voltaic cell comprising:
(a) cathode air flow hardware;
(b) a cathode gas diffusion layer;
(c) a cathode agar layer;
(d) an electrolyte layer comprising an ionically conductive medium in contact with an anode and a cathode;
(e) an anode layer for receiving electrons and providing electrons to an external circuit or load;
(f) an anode agar layer;
(g) a window layer; and
(h) a biofilm comprising a microbe.

32. The voltaic cell of claim 31, wherein the microbe resides in one or more of the cathode gas diffusion layer, cathode agar layer, electrolyte layer, anode layer, anode agar layer, and window layer.

33. The voltaic cell of claim 31, wherein the anode layer comprises material selected from the group consisting of aluminum nanoparticles, aluminum microparticles, transparent conductor particles, hydrophilic polymers, and hydrophilic gels.

34. The voltaic cell of claim 31, wherein the window layer comprises glass.
